(19) United States
(12) Patent Application Publication
(10) Pub. No.: US 2025/0315065 A1
(43) Pub. Date: Oct. 9, 2025

(54) SYSTEMS AND METHODS FOR SHIELDING USING DRONES

(71) Applicant: Menyou, LLC, Woodland Hills, CA (US)

(72) Inventor: Zachary PUGH, Bastrop, TX (US)

(21) Appl. No.: 19/244,561

(22) Filed: Jun. 20, 2025

Related U.S. Application Data
(63) Continuation of application No. PCT/US2025/021181, filed on Mar. 24, 2025.
(60) Provisional application No. 63/569,867, filed on Mar. 26, 2024.

(51) Int. Cl. G05D 1/686; B64F 1/35; B64U 70/90; B64U 101/05; B64U 101/64; G05D 1/69; G05D 107/00; G05D 109/25

(52) U.S. Cl. CPC G05D 1/686; B64F 1/35; B64U 70/90; G05D 1/69; B64U 2101/05; B64U 2101/64; G05D 2107/87; G05D 2109/254

(57) ABSTRACT

Disclosed herein are systems comprising: a swarm of unmanned aerial vehicles (UAV); a payload comprising a surface material; and a controller configured to perform operations comprising: connecting each UAV of the swarm to a plurality of connecting points of the payload, such that the swarm of UAVs is configured to collectively support and move the payload; deploying the payload to a selected location and at a selected shape above an environment to provide a selected degree of shade to the environment by directing each UAV of the swarm to hover at a selected location; and adjusting the selected location and/or the selected shape of the payload to track a trajectory of the sun by adjusting the selected location of each UAV of the swarm.

### CROSS-REFERENCE

This application is a continuation of the International Patent Application No. PCT/US2025/021181, filed on Mar. 24, 2025, which claims priority to U.S. Provisional Patent Application Ser. No. 63/569,867 filed Mar. 26, 2024, which is incorporated herein by reference in its entirety for all purposes.

### TECHNICAL FIELD

The present disclosure generally relates to systems and methods for controlling a swarm of unmanned aerial vehicles (UAVs) to provide coverage or shading. More particularly, the present disclosure relates to systems and methods designed to position and adjust a payload above an environment so that the payload can offer dynamic shade, collect or block rainwater, and track environmental conditions using coordinated UAV movements.

### BACKGROUND OF THE INVENTION

Fans attending events in open-air stadiums confront numerous sun-related challenges. Sunburn, discomfort from increased temperatures, and in extreme cases, heat exhaustion, become real risks. Glare from the sun may strain eyes and induce headaches, while higher temperatures may cause dehydration. Over time, persistent sun exposure may lead to skin aging, eye damage, and an elevated risk of skin cancer. Additionally, the sun's position may negatively impact the viewing experience and general comfort over a prolonged period. While wearing hats, sunscreen, sunglasses, and staying well-hydrated are effective precautions, they may only do so much.

Despite these challenges, covering every stadium isn't a feasible solution due to various constraints. The expense of construction and maintenance is hefty. Open-air venues are favored for certain sports where weather and traditional elements are integral to the game. Structural factors complicate the addition of roofs, and the aesthetics of open-air stadiums often hold appeal for fans. Furthermore, certain sports' regulations necessitate outdoor play. Natural light and ventilation, harder to mimic in covered venues, are another advantage of open stadiums. Retractable roofs may offer a flexible solution, but they incur even higher costs and maintenance needs.

### SUMMARY

The present disclosure pertains to aeronautical systems, specifically a swarm of unmanned aerial vehicles (SUAVs). These SUAVs are equipped with selective controls and paired with a payload for precise maneuvering and dynamic positioning, aimed at providing protection from sunlight, effectively casting the selected amount of shade, and/or to achieve specific payload placements. This novel approach utilizing UAVs offers a solution to the demand for sun protection in open-air stadiums without the need for building expensive infrastructures.

Provided herein are methods and systems for controlling a swarm of unmanned aerial vehicles (UAV) to move a payload.

Disclosed herein, in some embodiments is a system comprising: a swarm of unmanned aerial vehicles (UAV); a payload comprising a surface material; and a controller programmed to: connect each UAV of the swarm to a plurality of connecting points of the payload, such that the swarm of UAVs is configured to collectively support and move the payload; deploy each UAV of the swarm at a selected location such that the payload is held at a selected location and/or selected shape and is configured to provide a selected degree of shade to an environment; and adjust the selected location and/or the selected shape of the payload such that the payload is configured to track a trajectory of the sun. In some embodiments, the surface material comprises a plastic surface, paper surface, polymer surface, microfiber surface, or a surface suitable for displaying graphic information. In some embodiments, the surface material comprises a degree of translucency, and the controller is further programmed to adjust the degree of translucency based at least in part on an environmental condition. In some embodiments, one or more UAVs of the swarm comprises a sensor configured to detect the environmental condition, and wherein the environmental condition comprises one or more of an intensity of sunlight, a positioning of the sun, cloud coverage, rain, temperature, or a time of day. In some embodiments, the controller is further programmed to deploy a plurality of payloads above the environment. In some embodiments, the plurality of payloads are configured to provide a larger selected degree of shade to the environment, or wherein the plurality of payloads are configured to provide a degree of shade to a plurality of locations of the environment. In some embodiments, the controller is further programmed to switch out one or more UAVs of the swarm, as a battery level of one or more UAVs of the swarm reaches a drained state, with one or more newly charged UAVs from a charging station. In some embodiments, the environment comprises a stadium, and the payload is configured to provide a selected degree of shade to attendants in the stadium. In some embodiments, the environment comprises a stadium, and the swarm of UAVs is configured to hold the payload at an angle that matches an angle of seating in the stadium. In some embodiments, the payload comprises: (i) a display screen, (ii) an audio system, or (iii) a lighting system, and wherein the controller is further programmed to customize the content of the display screen, audio system, and/or lighting system to an event being held in the stadium. In some embodiments, one or more UAVs of the swarm comprises a photovoltaic cell. In some embodiments, the location and/or selected shape of the payload is further configured to block and collect rainwater. In some embodiments, the controller is further programmed to instruct the swarm of UAVs to transport collected rainwater to a selected location.

In one aspect, the embodiments herein disclose a method for controlling a swarm of unmanned aerial vehicles (UAVs), comprising: connecting a swarm of UAVs to a plurality of connecting points of a payload comprising a surface material; deploying the payload to a selected location and at a selected shape above an environment to provide a selected degree of shade to the environment by directing each UAV of the swarm to hover at a selected location; and adjusting the selected location and/or the selected shape of the payload to track a trajectory of the sun by adjusting the selected location of each UAV of the swarm. In some embodiments, the surface material comprises a plastic surface, paper surface, polymer surface, microfiber surface, or a surface suitable for displaying graphic information. In some embodiments, the surface material comprises a degree of translucency, and the method further comprises adjusting the degree of translucency based at least in part on an environmental condition. In some embodiments, the method further comprises detecting an environmental condition using a sensor of one or more UAVs of the swarm, and wherein the environmental condition comprises one or more of an intensity of sunlight, a positioning of the sun, cloud coverage, rain, temperature, or a time of day. In some embodiments, the method further comprises deploying a plurality of payloads above the environment. In some embodiments, deploying the plurality of payloads comprises positioning the plurality of payloads together to provide a larger selected degree of shade to the environment, or deploying the plurality of payloads at a plurality of individual selected locations to provide a degree of shade to a plurality of locations of the environment. In some embodiments, the method further comprises switching out one or more UAVs of the swarm, as a battery level of one or more UAVs of the swarm reaches a drained state, with one or more newly charged UAVs from a charging station. In some embodiments, the environment comprises a stadium, and the method further comprises deploying the payload to provide a selected degree of shade to attendants in the stadium. In some embodiments, wherein the environment comprises a stadium, and the method further comprises directing the swarm of UAVs to hold the payload at an angle that matches an angle of seating in the stadium. In some embodiments, the payload comprises: (i) a display screen, (ii) an audio system, or (iii) a lighting system, and wherein the method further comprises customizing the content of the display screen, audio system, and/or lighting system to an event being held in the stadium. In some embodiments, the method further comprises using one or more photovoltaic cells included on each UAV of the swarm to convert thermal or solar energy into electricity for use by the swarm of UAVs. In some embodiments, the method further comprises adjusting the selected location and/or selected shape of the payload to block and collect rainwater. In some embodiments, the method further comprises transporting the collected rainwater to a specified location.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents and patent applications incorporated by reference contradict the disclosure contained in the specification, the specification is intended to supersede and/or take precedence over any such contradictory material.

### BRIEF DESCRIPTION OF THE DRAWINGS

The novel features of the inventive concepts are set forth with particularity in the appended claims. A better understanding of the features and advantages of the present inventive concepts will be obtained by reference to the following detailed description that sets forth illustrative embodiments, in which the principles of the inventive concepts are utilized, and the accompanying drawings (also “Figure” and “FIG.” herein), of which:

FIG. 1A-FIG. 1C show non-limiting example of a system for using unmanned aerial vehicles for providing shade to an environment by tracking a trajectory of the sun, according to embodiments disclosed herein. FIG. 1A schematically illustrates a system for providing shade to an environment as the sun may be rising, according to embodiments disclosed herein. FIG. 1B schematically illustrates a system for providing shade to an environment as the sun may be at its highest point in a day, according to embodiments disclosed herein. FIG. 1C schematically illustrates a system for providing shade to an environment as the sun may be setting, according to embodiments disclosed herein.

FIG. 2A-FIG. 2C shows a non-limiting example of how the unmanned aerial vehicles may alter the shape of a surface material used for providing shade to an environment; according to embodiments disclosed herein. FIG. 2A schematically illustrates the unmanned aerial vehicles holding a surface material in inverted U-shape, according to embodiments disclosed herein. FIG. 2B schematically illustrates how the unmanned aerial vehicles may hold multiple points of surface material at different elevations, according to embodiments disclosed herein. FIG. 2C schematically illustrates how the surface material may include a plurality of connecting points for the unmanned aerial vehicles, allowing the UAV devices to create of plurality of two dimensional (2D) shapes of the surface material, according to embodiments disclosed herein.

FIG. 3A-FIG. 3C schematically illustrate how the surface material may adjust translucency, according to embodiments disclosed herein. FIG. 3A schematically illustrates how a surface material may utilize little to no translucency as a sun may be at its highest position in a day, according to embodiments disclosed herein. FIG. 3B schematically illustrates how a surface material may utilize increased translucency to let more light pass through as the sun may be setting, according to embodiments disclosed herein. FIG. 3C schematically illustrates how a surface material may utilize increased translucency to let more light pass through based on an environmental condition that (e.g., cloud coverage) may affect the amount of sunlight hitting a given environment, according to embodiments disclosed herein.

FIG. 4 schematically illustrates how multiple unmanned drone systems may be utilized to hold up multiple surface materials above a given environment, according to embodiments disclosed herein.

FIG. 5A-FIG. 5C schematically illustrate how the system and surface material may be customized to a given environment, according to embodiments disclosed herein. FIG. 5A schematically illustrates how the unmanned aerial vehicles may hold a surface material at an angle that matches an angle of the environment (e.g., stadium seating), according to embodiments disclosed herein. FIG. 5B schematically illustrates how a surface material may include a screen for displaying information to an audience (e.g., beneath the surface material), according to embodiments disclosed herein. FIG. 5C schematically illustrates how a surface material may include a screen, sound and lighting systems, according to embodiments disclosed herein.

FIG. 6A-FIG. 6B schematically illustrate how fully charged unmanned aerial vehicles may be used to switch out unmanned aerial vehicles on low battery, according to embodiments disclosed herein. FIG. 6A schematically illustrates how fully charged unmanned aerial vehicles from a docking station may be used to switch out low battery drone devices holding up a surface material, such that the surface material never need be lowered, according to embodiments disclosed herein. FIG. 6B schematically illustrates how a fully charged unmanned aerial vehicle and surface material system may be used to switch out a low battery drone device and surface material system, according to embodiments disclosed herein.

FIG. 7 shows a non-limiting example of a computing device, in accordance with embodiments disclosed herein.

FIG. 8 shows a non-limiting example of a mobile application provision system in accordance with embodiments disclosed herein.

FIG. 9 shows a non-limiting example of a cloud-based mobile application provision system, in accordance with embodiments disclosed herein.

FIG. 10 shows a non-limiting example of methods disclosed herein, in accordance with embodiments disclosed herein.

FIG. 11 shows a non-limiting example of a computing system for controlling the system, in accordance with embodiments disclosed herein.

### DETAILED DESCRIPTION

The present disclosure pertains to aeronautical systems, specifically a swarm of unmanned aerial vehicles (SUAVs). These SUAVs are equipped with selective controls and paired with a payload for precise maneuvering and dynamic positioning, aimed at providing protection from sunlight, effectively casting the selected amount of shade, and/or to achieve specific payload placements. This novel approach utilizing UAVs offers a solution to the demand for sun protection in open-air stadiums without the need for building expensive infrastructures.

The devices, systems, and methods provided herein may improve over devices, systems, and methods in the art by providing, in certain embodiment a system comprising SUAVs, payloads, and controls configured to provides various benefits, including but not limited to providing sun cover, and/or a display with accompanying sound, lighting and visual content.

In some embodiments, the UAV swarm coordinates via a distributed control algorithm that processes GPS and inertial data. In some cases, each UAV maintains peer-to-peer communication at short intervals, updating swarm members on position and battery status. In some instances, the swarm employs consensus-based or Kalman-filtered approaches to converge on stable flight formations. For example, when a gust of wind shifts part of the canopy, multiple UAVs autonomously adjust pitch and throttle to counteract drift. As an example, the system may switch from a high-precision mode (for exact positioning) to a power-saving mode when conditions are stable. In some instances, onboard cameras or vision systems provide detection of the sun's position or stadium boundaries. For example, these cameras may look for visual markers on the stadium rim to maintain a precise offset distance. As an example, such visual tracking helps the canopy remain correctly oriented to block direct sunlight for spectators below.

Provided herein are methods and systems for controlling a swarm of unmanned aerial vehicles (SUAVs) to move a payload.

The SUAVs may comprise a drone matrix. In some cases, the drone matrix may comprise an array or group of UAV positioned in a particular structure or configuration. In some cases, the drone matrix may comprise a network of interconnected UAV working together to perform a task.

In some cases, the swarm of UAVs may comprise one or more UAVs. In some cases, the swarm of UAVs may act in concert. In some instances, the swarm of UAVs may act in concert to achieve a same selected result. For example, the swarm of UAVs may act in concert to deliver a payload. In some cases, the swarm of UAVs may act independently. In some instances, the swarm of UAVs may act independently to achieve a plurality of selected results.

A UAV may include a UAV body. The UAV body may be a central body. A center of gravity of the UAV may be within the UAV body, above a UAV body, or below a UAV body. A center of gravity of the UAV may pass through an axis extending vertically through the UAV body. The UAV body may support one or more arms of the UAV. The UAV body may bear weight of the one or more arms. The UAV body may directly contact one or more arms. The UAV body may be integrally formed with one or more arms or components of one or more arms. The UAV may connect to the one or more arms via one or more intermediary pieces.

The UAV body may be formed from a solid piece. Alternatively, the UAV body may be hollow or may include one or more cavities therein. The UAV body may have any shape. The UAV may have a substantially disc-like shape in some embodiments.

Any description herein of a UAV may apply to any type of aerial vehicle or movable object, or vice versa. The UAV may comprise a multi-rotor drone, fixed-wing drone, single-rotor helicopter drone, fixed-wing hybrid VTOL drone, nano drone, tricopter drone, delivery drone, racing drone, surveillance drone, or agricultural drone.

In some cases, the UAV may comprise a nano drone. In some instances, the nano drone is small enough to fit in the palm of a human hand. For example, the nano drone may comprise less than 10 cm (4 inches) in diameter.

In some cases, the UAV may comprise a small drone. In these instances, the small drone is larger than a nano drone, often used for recreational purposes and basic commercial applications. For example, the small drone may range from about 10 cm (4 inches) up to about 80 cm (31.5 inches) in size (e.g., the size is a longest dimension of the drone).

In some cases, the UAV may constitute a medium drone. In some instances, the medium drone is larger than a small drone and is typically used for more complex tasks such as professional photography and surveying. For example, the medium drone may range from about 80 cm (31.5 inches) up to about 2 meters (6.6 feet) in size (e.g., the size is a longest dimension of the drone).

In some cases, the UAV may comprise a large drone. In some instances, the large drone is larger than medium UAV and is used for advanced tasks such as agricultural or industrial purposes. For example, the large drone may comprise larger than about 2 meters (6.6 feet), sometimes being as large as a small aircraft (e.g., the size is a longest dimension of the drone).

The UAV body may include a housing that may partially or completely enclose one or more components therein. The components may include one or more electrical components. Examples of components may comprise one or more of, a flight controller, one or more processors, one or more memory storage units, a communication unit, a display, a navigation unit, one or more sensors, a power supply and/or control unit, one or more electronic speed control (ESC) modules, one or more inertial measurement units (IMU) or any other components. Examples of sensors on a UAV (e.g., which may be within the housing, outside the housing, embedded in the housing, or any combination thereof) may include one or more of the following: one or more sensors may comprise one or more of: a global positioning system (GPS) sensor, a vision sensor, a temperature sensor, a lidar sensor, an ultrasonic sensor, a barometer, or an altimeter. Any sensor suitable for collecting environmental information may be used, including location sensors (e.g., GPS sensors, mobile device transmitters providing location triangulation), vision sensors (e.g., imaging devices capable of detecting visible, infrared, or ultraviolet light, such as cameras), proximity sensors (e.g., ultrasonic sensors, lidar, time-of-flight cameras), inertial sensors (e.g., accelerometers, gyroscopes, inertial measurement units (IMUs)), altitude sensors, pressure sensors (e.g., barometers), audio sensors (e.g., microphones) or field sensors (e.g., magnetometers, electromagnetic sensors). Any suitable number and combination of sensors may be used, such as one, two, three, four, five, or more sensors.

Similarly, any of the components described may be disposed on, within, or embedded in an arm of the UAV. The arms may optionally include one or more cavities that may house one or more of the components (e.g., electrical components). In one example, the arms may or may not have inertial sensors that may provide information about a position (e.g., orientation, spatial location) or movement of the arms. The various components described may be distributed on a body of the UAV, the arms of the UAV, or any combination thereof.

In some embodiments, the drones may carry additional sensors. In some cases, these sensors comprise thermal imaging devices or crowd-density detectors. In some cases, these sensors capture data on heat buildup or population flow beneath the canopy, relaying insights for on-the-fly adjustments. In some instances, the swarm may selectively concentrate shading or cooling features where crowds are largest or temperatures highest. For example, if thermal sensors detect hot spots over a certain seating block, more drones may reposition to thicken the canopy layer in that region. As an example, the same sensor suite may be used to gauge water usage or measure localized rainfall to guide irrigation in an agricultural setup. In some instances, the entire analytics pipeline is stored in a database accessible by venue operators or management software. For example, long-term data on crowd behavior and shading effectiveness may inform future event planning and energy-saving strategies. As an example, the synergy between real-time analytics and UAV-based canopy positioning creates a highly adaptive environment.

In some embodiments, the shading system uses a heterogeneous fleet of UAVs with varying lift capacities and sensor loadouts. In some cases, heavier drones handle the main canopy sections while lighter scout drones focus on fine-tuning or edge tensioning. In some instances, separate swarms may coordinate to cover different parts of a large stadium or multiple venues simultaneously. For example, each swarm may communicate via inter-swarm protocols, ensuring no overlap or midair interference. As an example, the overall system may unify coverage data so that event organizers have a single interface to manage all active swarms. In some instances, a specialized “leader” UAV per swarm may act as the local coordinator, offloading some tasks from a global central server. For example, the leader UAV may handle immediate collision avoidance, distributing instructions to the swarm's members within its vicinity. As an example, such hierarchical control structures enhance scalability and reduce latency in large-scale deployments.

In some embodiments, each UAV adheres to regional civil aviation regulations by implementing geo-fencing and altitude restrictions. In some cases, the UAV software cross-references its GPS location with restricted airspace maps to automatically prevent unauthorized intrusion. In some instances, integrated collision-avoidance systems use ultrasonic sensors or radar to detect obstacles, including other drones, stadium fixtures, or spectators. For example, the UAV swarm may slow or alter path if any single drone's sensor indicates a potential hazard within a predefined buffer distance. As an example, flight logs and telemetry data may be stored for post-event compliance review or incident analysis. In some instances, the system may operate only when certain safety thresholds—like crowd clearances or event checklists—are satisfied. For example, an operator may input “crowd-safety mode” limiting maximum UAV speed and altitude until the event concludes. As an example, strict adherence to these measures ensures that dynamic shading does not compromise public safety.

In some embodiments, the drone-based shading system may benefit agricultural sites by regulating sunlight for crops in large open fields. In some cases, partial coverage strategies reduce soil evaporation and protect delicate plants from excessive UV exposure. In some instances, the same multi-UAV approach may be configured to serve as portable roofing for construction sites or disaster-relief areas. For example, a lightweight membrane may be used in emergency shelters, with drones periodically reorienting it for improved weather protection. As an example, combining shading and optional sensors allows relief workers to monitor temperature, humidity, or contamination levels. In some instances, specialized attachments may convert the canopy into a net or surface for aerial seeding, delivering seeds across wide tracts of land. For example, the swarm may hover at a controlled altitude while distributing seeds through a vibrating dispenser integrated into the payload. As an example, these broad applications underscore the adaptability and commercial viability of drone-based canopy and payload systems.

An assistant arm may be configured so that while in a flight configuration, the assistant arm does not interfere with the functional space of the payload. In a landing configuration, the assistant arm may interfere with the functional space of the payload. Thus, the functional space of the payload may be increased when the UAV is in flight and may be decreased when the UAV is landed. The functional space of the payload may be increased when one or more assistant arms are in a flight configuration and may be decreased when the one or more assistant arms are in a landing configuration.

For example, the payload may be a camera. The camera may have a field of view that is unobstructed by the arms of the UAV when the UAV is in flight. The camera may have a field of view that is obstructed by one or more arms of the UAV when the UAV is landed. The camera may have a field of view that is unobstructed when the UAV the one or more assistant arms are in a flight configuration. The camera may have a field of view that is obstructed by a portion of the one or more assistant arms when the one or more assistant arms in a landing configuration. The field of view may be unobstructed for a 360 degree panoramic view around the camera when the UAV is in flight. The camera may rotate to capture a 360 panoramic view (e.g., about a yaw axis). The camera may be permitted to rotate at least 360 degrees, at least 720 degrees, or even more.

The decreased functional space (e.g., obstruction to a potential field of view of a camera) may during landing may be acceptable since the UAV is on the ground, while allowing the UAV to have increased functional space (e.g., a potential 360 degree panoramic view) while the UAV is flying around.

Flight of the UAV may be controlled with aid of a remote terminal. A user may interact with the remote terminal to control flight of the UAV. The remote terminal may initiate flight of the UAV and/or landing of the UAV. The remote terminal may or may not directly control transformation of one or more arms of the UAV. In some instances, the transformation of the one or more arms may occur automatically in response to a sensed condition, or a command to land or take-off. The remote terminal may initiate one or more predetermined flight sequence or a type of flight mode. The UAV may be capable of autonomous, semi-autonomous, or direct manual controlled flight.

Operation of one or more components of the UAV may be controlled with aid of a remote terminal. The remote terminal controlling operation of the one or more components of the UAV may be the same as a remote terminal controlling flight of the UAV or may be a different device from the remote terminal controlling flight of the UAV. The remote terminal may control operation of a payload, such as a camera. The remote terminal may control positioning of the payload. The remote terminal may control operation of a carrier that supports the payload, which may affect positioning of the payload. The remote terminal may affect operation of one or more sensors carried by the UAV.

It shall be understood that different aspects of the invention may be appreciated individually, collectively, or in combination with each other. Various aspects of the invention described herein may be applied to any of the particular applications set forth below or for any other types of movable objects. Any description herein of an aerial vehicle may apply to and be used for any movable object, such as any vehicle. Additionally, the devices and methods disclosed herein in the context of aerial motion (e.g., flight) may also be applied in the context of other types of motion, such as movement on the ground or on water, underwater motion, or motion in space.

Other objects and features of the invention will become apparent by a review of the specification, claims, and appended figures.

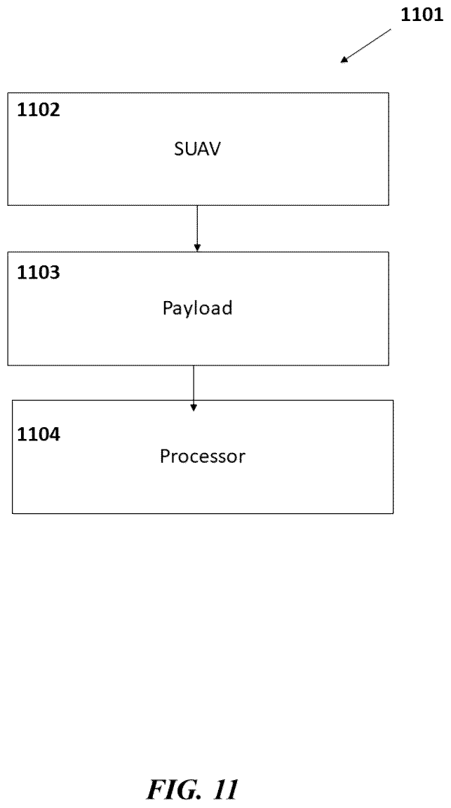

Disclosed herein are computer systems configured to control the system comprising the swarm of UAVs and a payload. FIG. 11 shows a non-limiting example of a computing system 1100 for controlling the system, wherein the system comprises the swarm of UAVs, the payload and the processor. In this embodiment, the server further comprises components configured for controlling the system comprising the swarm of UAVs, payload and processor.

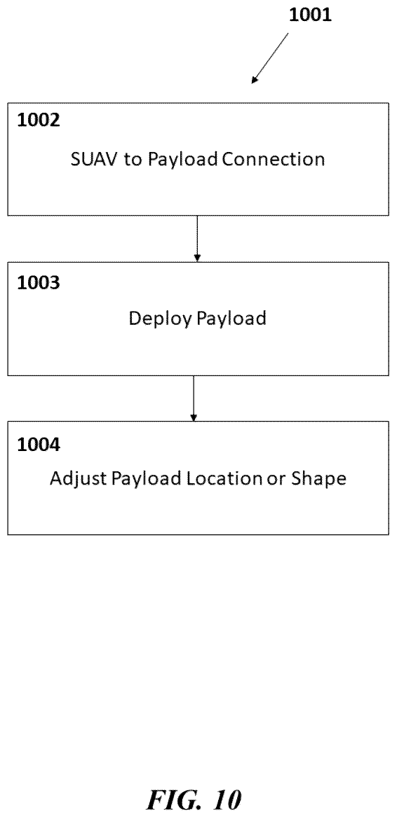

Provided herein are computer-implemented methods for, controlling the system having the swarm of unmanned aerial vehicles and the payload. FIG. 10 shows a non-limiting example of the methods disclosed herein for controlling the system comprising connecting a swarm of unmanned aerial vehicles to a payload, deploying the payload and adjusting the payload location or shape. The method 1001 begins at 1002, where the system with the aid of one or more processors, connects a swarm of unmanned aerial vehicles (UAV) to a plurality of connecting points of a payload comprising a surface material. In some cases, the method continues at 1003 wherein the method deploying the payload to a selected location and at a selected shape above an environment to provide a selected degree of shade to the environment by directing each UAV of the swarm to hover at a selected location. In some instances, the method continues at 1004 wherein the method adjusts the selected location and/or the selected shape of the payload to track a trajectory of the sun by adjusting the selected location of each UAV of the swarm. The methods and system will be described in further detail herein.

The system may comprise an environment. In some cases, the system comprises a swarm of UAVs configured for an environment. In some cases, the system comprises a payload configured for an environment.

In some cases, the environment comprises a stadium. In some instances, the stadium may comprise a football stadium, a baseball stadium, a basketball stadium/arena, a cricket stadium, a rugby stadium, an athletics stadium/track and field stadium, a multipurpose stadium, an indoor arena, a motorsport stadium, a tennis stadium, a domed stadium, an open-air stadium, or a roofed stadium.

In some cases, the environment may comprise a size in square feet between about 0 square feet (sq. ft.) to about 4 million sq. ft.

In some cases, the environment may comprise a size in square feet between about 0 sq. ft. to about 4,000,000 sq. ft. In some cases, the environment may comprise a size in square feet between about 0 sq. ft. to about 5 sq. ft., about 0 sq. ft. to about 15,000 sq. ft., about 0 sq. ft. to about 25,000 sq. ft., about 0 sq. ft. to about 50,000 sq. ft., about 0 sq. ft. to about 75,000 sq. ft., about 0 sq. ft. to about 100,000 sq. ft., about 0 sq. ft. to about 250,000 sq. ft., about 0 sq. ft. to about 500,000 sq. ft., about 0 sq. ft. to about 1,000,000 sq. ft., about 0 sq. ft. to about 2,500,000 sq. ft., about 0 sq. ft. to about 4,000,000 sq. ft., about 5 sq. ft. to about 15,000 sq. ft., about 5 sq. ft. to about 25,000 sq. ft., about 5 sq. ft. to about 50,000 sq. ft., about 5 sq. ft. to about 75,000 sq. ft., about 5 sq. ft. to about 100,000 sq. ft., about 5 sq. ft. to about 250,000 sq. ft., about 5 sq. ft. to about 500,000 sq. ft., about 5 sq. ft. to about 1,000,000 sq. ft., about 5 sq. ft. to about 2,500,000 sq. ft., about 5 sq. ft. to about 4,000,000 sq. ft., about 15,000 sq. ft. to about 25,000 sq. ft., about 15,000 sq. ft. to about 50,000 sq. ft., about 15,000 sq. ft. to about 75,000 sq. ft., about 15,000 sq. ft. to about 100,000 sq. ft., about 15,000 sq. ft. to about 250,000 sq. ft., about 15,000 sq. ft. to about 500,000 sq. ft., about 15,000 sq. ft. to about 1,000,000 sq. ft., about 15,000 sq. ft. to about 2,500,000 sq. ft., about 15,000 sq. ft. to about 4,000,000 sq. ft., about 25,000 sq. ft. to about 50,000 sq. ft., about 25,000 sq. ft. to about 75,000 sq. ft., about 25,000 sq. ft. to about 100,000 sq. ft., about 25,000 sq. ft. to about 250,000 sq. ft., about 25,000 sq. ft. to about 500,000 sq. ft., about 25,000 sq. ft. to about 1,000,000 sq. ft., about 25,000 sq. ft. to about 2,500,000 sq. ft., about 25,000 sq. ft. to about 4,000,000 sq. ft., about 50,000 sq. ft. to about 75,000 sq. ft., about 50,000 sq. ft. to about 100,000 sq. ft., about 50,000 sq. ft. to about 250,000 sq. ft., about 50,000 sq. ft. to about 500,000 sq. ft., about 50,000 sq. ft. to about 1,000,000 sq. ft., about 50,000 sq. ft. to about 2,500,000 sq. ft., about 50,000 sq. ft. to about 4,000,000 sq. ft., about 75,000 sq. ft. to about 100,000 sq. ft., about 75,000 sq. ft. to about 250,000 sq. ft., about 75,000 sq. ft. to about 500,000 sq. ft., about 75,000 sq. ft. to about 1,000,000 sq. ft., about 75,000 sq. ft. to about 2,500,000 sq. ft., about 75,000 sq. ft. to about 4,000,000 sq. ft., about 100,000 sq. ft. to about 250,000 sq. ft., about 100,000 sq. ft. to about 500,000 sq. ft., about 100,000 sq. ft. to about 1,000,000 sq. ft., about 100,000 sq. ft. to about 2,500,000 sq. ft., about 100,000 sq. ft. to about 4,000,000 sq. ft., about 250,000 sq. ft. to about 500,000 sq. ft., about 250,000 sq. ft. to about 1,000,000 sq. ft., about 250,000 sq. ft. to about 2,500,000 sq. ft., about 250,000 sq. ft. to about 4,000,000 sq. ft., about 500,000 sq. ft. to about 1,000,000 sq. ft., about 500,000 sq. ft. to about 2,500,000 sq. ft., about 500,000 sq. ft. to about 4,000,000 sq. ft., about 1,000,000 sq. ft. to about 2,500,000 sq. ft., about 1,000,000 sq. ft. to about 4,000,000 sq. ft., or about 2,500,000 sq. ft. to about 4,000,000 sq. ft. In some cases, the environment may comprise a size in square feet between about 0 sq. ft., about 5 sq. ft., about 15,000 sq. ft., about 25,000 sq. ft., about 50,000 sq. ft., about 75,000 sq. ft., about 100,000 sq. ft., about 250,000 sq. ft., about 500,000 sq. ft., about 1,000,000 sq. ft., about 2,500,000 sq. ft., or about 4,000,000 sq. ft. In some cases, the environment may comprise a size in square feet between at least about 0 sq. ft., about 5 sq. ft., about 15,000 sq. ft., about 25,000 sq. ft., about 50,000 sq. ft., about 75,000 sq. ft., about 100,000 sq. ft., about 250,000 sq. ft., about 500,000 sq. ft., about 1,000,000 sq. ft., or about 2,500,000 sq. ft. In some cases, the environment may comprise a size in square feet between at most about 5 sq. ft., about 15,000 sq. ft., about 25,000 sq. ft., about 50,000 sq. ft., about 75,000 sq. ft., about 100,000 sq. ft., about 250,000 sq. ft., about 500,000 sq. ft., about 1,000,000 sq. ft., about 2,500,000 sq. ft., or about 4,000,000 sq. ft.

In some cases, the environment may comprise an outdoor environment. In some instances, the outdoor environment may comprise forests, grasslands, deserts, tundra, wetlands, mountains, oceans and seas, rivers and lakes, polar regions, urban environments, agricultural land, islands, jungles, or beaches. In some instances, the outdoor environment may comprise a park. In some instances, the outdoor environment may comprise a road.

In some cases, the environment may comprise an indoor environment. In some instances, the indoor environment may comprise a residential environment, a commercial environment, an educational environment, a healthcare environment, a recreational environment, a hospitality environment, an industrial environment, a religious environment, a transport environment, a public and government environment, a cultural environment, a scientific environment, a correctional environment, or an underground environment. In some instances, the indoor environment may comprise a home.

The swarm of unmanned aerial vehicles (SUAV) may comprise a payload. In some cases, the payload comprises the cargo carried by the unmanned aerial vehicle (e.g., UAV or SUAV). In some instances, the payload may comprise any cargo configurable to be attached or connected to at least one UAV.

The payload may comprise any material or object. In some cases, the payload may comprise imaging devices, sensors, communication equipment, delivery packages, emergency supplies, geophysical tools, payloads for scientific research, weapons, agricultural sprayers, 3D mapping equipment, or search and rescue equipment.

In some cases, the payload comprises a surface material. In some instances, the surface material comprises a plastic surface. In some instances, the surface material comprises a paper surface. In some instances, the surface material comprises a polymer surface. In some instances, the surface material comprises a microfiber surface. In some instances, the surface material comprises a surface suitable for displaying graphic information.

In some cases, the payload comprises a shading material. In some instances, the surface material may be configured to also function as shading material. In some instances, the shading material may comprise one or more of canvas, polyester or polyethylene tarp, wood, metals, shade cloth, bamboo or reed screening, umbrella fabric, vinyl or pvc, or polycarbonate roof panels.

In some embodiments, the shading surface comprises electrochromic or photochromic films to modulate translucency under electrical or light stimuli. In some cases, a voltage differential is applied across the film to switch between near-transparent and opaque states. In some instances, an onboard sensor array detects sunlight intensity or ambient temperature and autonomously adjusts the film's transparency. For example, the canopy may darken during peak sun hours to reduce heat and UV exposure over seating areas. As an example, in overcast conditions, the system may allow more natural light through to maintain visibility. In some instances, mechanical louvers or partial shutters may be embedded in the membrane to block direct glare while permitting airflow. For example, these shutters may open or close in segments, creating targeted shading for different stadium sections. As an example, the dynamic control of translucency and airflow may enhance overall spectator comfort and energy efficiency.

In some cases, the payload comprises a mesh material. In some instances, the mesh material may comprise one or more of a wire mesh, plastic mesh, fiberglass mesh, netting, polyester mesh, nylon mesh, polyethylene mesh, metal mesh, cotton mesh, or mesh fabric.

In some cases, the payload comprises a screen material. In some instances, the screen material may comprise one or more of a fiberglass screen, an aluminum screen, a pet screen, a solar screen, a bronze/copper/brass/stainless steel screen, a retractable screen, a security screen, a porch screen, a projector screen material, or a polyester screen.

In some cases, the payload may comprise a power source. In some cases, the SUAVs may comprise a power source. In some instances, the power source may be configured to power the SUAVs. In some instances, the power source may be configured to power other components of the payload. In some instances, the power source may be configured to power the SUAVs and the payload. For example, the power source may comprise one or more of a solar power source, wind power source, hydroelectric power source, geothermal power source, fossil fuel power source, nuclear power source, tidal power source, biomass energy power source, battery power source, or fuel cell power source. In some instances, the mesh/screen material comprises a photovoltaic cell (e.g., one or more photovoltaic or solar panels) for powering the system.

The surface material may comprise a degree of translucency. In some cases, the surface material comprise a degree of translucency between about 0% to about 100%. In some cases, the surface material comprise a degree of translucency between about 0% to about 10%, about 0% to about 20%, about 0% to about 30%, about 0% to about 40%, about 0% to about 50%, about 0% to about 60%, about 0% to about 70%, about 0% to about 80%, about 0% to about 90%, about 0% to about 99%, about 0% to about 100%, about 10% to about 20%, about 10% to about 30%, about 10% to about 40%, about 10% to about 50%, about 10% to about 60%, about 10% to about 70%, about 10% to about 80%, about 10% to about 90%, about 10% to about 99%, about 10% to about 100%, about 20% to about 30%, about 20% to about 40%, about 20% to about 50%, about 20% to about 60%, about 20% to about 70%, about 20% to about 80%, about 20% to about 90%, about 20% to about 99%, about 20% to about 100%, about 30% to about 40%, about 30% to about 50%, about 30% to about 60%, about 30% to about 70%, about 30% to about 80%, about 30% to about 90%, about 30% to about 99%, about 30% to about 100%, about 40% to about 50%, about 40% to about 60%, about 40% to about 70%, about 40% to about 80%, about 40% to about 90%, about 40% to about 99%, about 40% to about 100%, about 50% to about 60%, about 50% to about 70%, about 50% to about 80%, about 50% to about 90%, about 50% to about 99%, about 50% to about 100%, about 60% to about 70%, about 60% to about 80%, about 60% to about 90%, about 60% to about 99%, about 60% to about 100%, about 70% to about 80%, about 70% to about 90%, about 70% to about 99%, about 70% to about 100%, about 80% to about 90%, about 80% to about 99%, about 80% to about 100%, about 90% to about 99%, about 90% to about 100%, or about 99% to about 100%. In some cases, the surface material comprise a degree of translucency between about 0%, about 10%, about 20%, about 30%, about 40%, about 50%, about 60%, about 70%, about 80%, about 90%, about 99%, or about 100%. In some cases, the surface material comprise a degree of translucency between at least about 0%, about 10%, about 20%, about 30%, about 40%, about 50%, about 60%, about 70%, about 80%, about 90%, or about 99%. In some cases, the surface material comprise a degree of translucency between at most about 10%, about 20%, about 30%, about 40%, about 50%, about 60%, about 70%, about 80%, about 90%, about 99%, or about 100%.

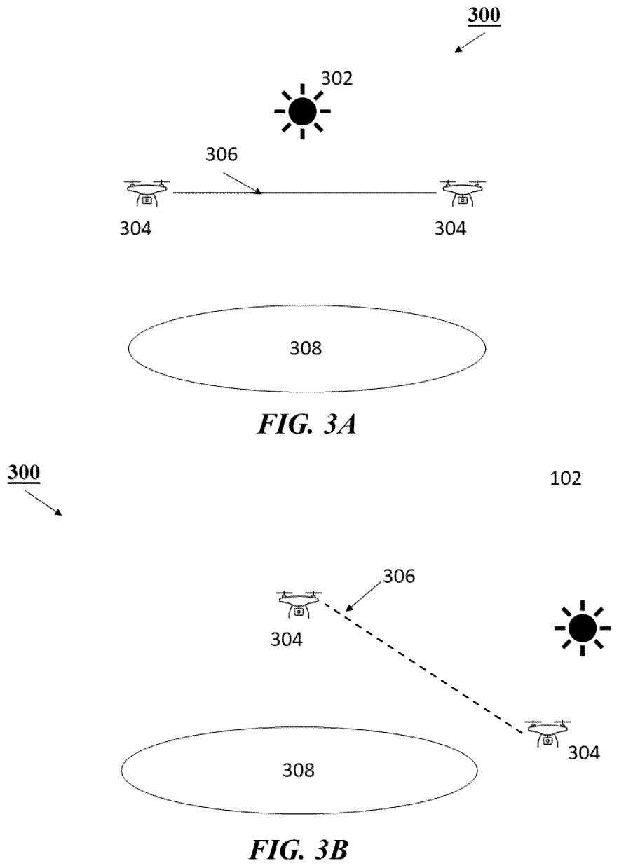

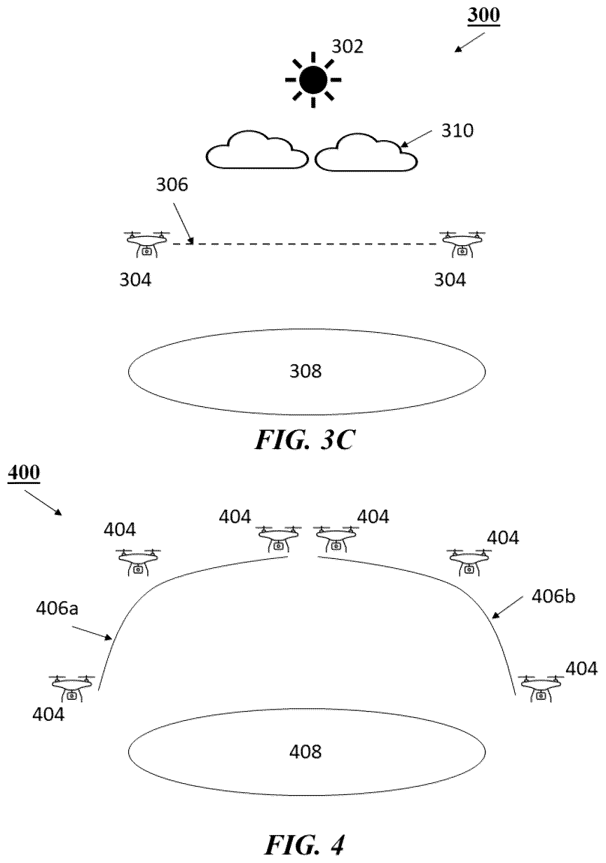

FIG. 3A schematically illustrates how a surface material may utilize little to no translucency as a sun may be at its highest position in a day. In the example of FIG. 3A, the system 300 may comprise a swarm of unmanned aerial vehicles 304 and a surface material 306. In FIG. 3A, the sun 302 is at its highest position in the day. Further, in FIG. 3A, the surface material 306 is positioned above the environment 308 and below the sun 302. For example, in FIG. 3A, the surface material occludes the sunlight to a degree of translucency configured to permit a selected amount of sunlight.

In some cases, the sun is at its highest point. In some instances, wherein the sun is at its highest point, an intensity of sunlight comprises up to about 1000 watts per square meter. In some instances, wherein the sun is at its highest point, the surface material comprises a degree of translucency between about 70% to about 100%. In some instances, wherein the sun is at its highest point, the surface material comprises a degree of translucency between about 70% to about 73%, about 70% to about 76%, about 70% to about 79%, about 70% to about 82%, about 70% to about 85%, about 70% to about 88%, about 70% to about 91%, about 70% to about 94%, about 70% to about 97%, about 70% to about 99%, about 70% to about 100%, about 73% to about 76%, about 73% to about 79%, about 73% to about 82%, about 73% to about 85%, about 73% to about 88%, about 73% to about 91%, about 73% to about 94%, about 73% to about 97%, about 73% to about 99%, about 73% to about 100%, about 76% to about 79%, about 76% to about 82%, about 76% to about 85%, about 76% to about 88%, about 76% to about 91%, about 76% to about 94%, about 76% to about 97%, about 76% to about 99%, about 76% to about 100%, about 79% to about 82%, about 79% to about 85%, about 79% to about 88%, about 79% to about 91%, about 79% to about 94%, about 79% to about 97%, about 79% to about 99%, about 79% to about 100%, about 82% to about 85%, about 82% to about 88%, about 82% to about 91%, about 82% to about 94%, about 82% to about 97%, about 82% to about 99%, about 82% to about 100%, about 85% to about 88%, about 85% to about 91%, about 85% to about 94%, about 85% to about 97%, about 85% to about 99%, about 85% to about 100%, about 88% to about 91%, about 88% to about 94%, about 88% to about 97%, about 88% to about 99%, about 88% to about 100%, about 91% to about 94%, about 91% to about 97%, about 91% to about 99%, about 91% to about 100%, about 94% to about 97%, about 94% to about 99%, about 94% to about 100%, about 97% to about 99%, about 97% to about 100%, or about 99% to about 100%. In some instances, wherein the sun is at its highest point, the surface material comprises a degree of translucency between about 70%, about 73%, about 76%, about 79%, about 82%, about 85%, about 88%, about 91%, about 94%, about 97%, about 99%, or about 100%. In some instances, wherein the sun is at its highest point, the surface material comprises a degree of translucency between at least about 70%, about 73%, about 76%, about 79%, about 82%, about 85%, about 88%, about 91%, about 94%, about 97%, or about 99%. In some instances, wherein the sun is at its highest point, the surface material comprises a degree of translucency between at most about 73%, about 76%, about 79%, about 82%, about 85%, about 88%, about 91%, about 94%, about 97%, about 99%, or about 100%.

FIG. 3B schematically illustrates how a surface material may utilize increased translucency to let more light pass through as the sun may be setting. In the example of FIG. 3B, the system 300 may comprise a swarm of unmanned aerial vehicles 304 and a surface material 306. In FIG. 3B, the sun 302 is setting (e.g., nearing its lowest point in the day). Further, in FIG. 3B, the surface material 306 is positioned between the environment 308 and the sun 302. For example, in FIG. 3B, the surface material 306 occludes the sunlight to a degree of translucency configured to permit a selected amount of sunlight. In further example, the swarm of unmanned aerial vehicles 304 may be configured to position the surface material 306 at an angle (e.g., the angle at which the sun makes with the environment).

In some cases, the sun is setting. In some instances, wherein the sun is setting, an intensity of sunlight comprises less than about 1000 watts per square meter. In some instances, wherein the sun is setting, the surface material comprises a degree of translucency between about 30% to about 85%. In some instances, wherein the sun is setting, the surface material comprises a degree of translucency between about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 35% to about 40%, about 35% to about 45%, about 35% to about 50%, about 35% to about 55%, about 35% to about 60%, about 35% to about 65%, about 35% to about 70%, about 35% to about 75%, about 35% to about 80%, about 35% to about 85%, about 40% to about 45%, about 40% to about 50%, about 40% to about 55%, about 40% to about 60%, about 40% to about 65%, about 40% to about 70%, about 40% to about 75%, about 40% to about 80%, about 40% to about 85%, about 45% to about 50%, about 45% to about 55%, about 45% to about 60%, about 45% to about 65%, about 45% to about 70%, about 45% to about 75%, about 45% to about 80%, about 45% to about 85%, about 50% to about 55%, about 50% to about 60%, about 50% to about 65%, about 50% to about 70%, about 50% to about 75%, about 50% to about 80%, about 50% to about 85%, about 55% to about 60%, about 55% to about 65%, about 55% to about 70%, about 55% to about 75%, about 55% to about 80%, about 55% to about 85%, about 60% to about 65%, about 60% to about 70%, about 60% to about 75%, about 60% to about 80%, about 60% to about 85%, about 65% to about 70%, about 65% to about 75%, about 65% to about 80%, about 65% to about 85%, about 70% to about 75%, about 70% to about 80%, about 70% to about 85%, about 75% to about 80%, about 75% to about 85%, or about 80% to about 85%. In some instances, wherein the sun is setting, the surface material comprises a degree of translucency between about 30%, about 35%, about 40%, about 45%, about 50%, about 55%, about 60%, about 65%, about 70%, about 75%, about 80%, or about 85%. In some instances, wherein the sun is setting, the surface material comprises a degree of translucency between at least about 30%, about 35%, about 40%, about 45%, about 50%, about 55%, about 60%, about 65%, about 70%, about 75%, or about 80%. In some instances, wherein the sun is setting, the surface material comprises a degree of translucency between at most about 35%, about 40%, about 45%, about 50%, about 55%, about 60%, about 65%, about 70%, about 75%, about 80%, or about 85%.

In some cases, the surface material degree of translucency may be configured for an environmental condition. In some instances, one or more UAVs of a swarm of UAVs may include a sensor to help detect the environmental condition. In some instances, the environmental condition comprises an intensity of sunlight. For example, the intensity of the sunlight may comprise up to about 1000 watts per square meter and the surface material may comprise a degree of translucency between about 70% to about 100%. For example, the intensity of the sunlight may comprise between about 100 watts per square meter and about 1000 watts per square meter and the surface material may comprise a degree of translucency between about 35% to about 85%.

In some instances, the environmental condition comprises a positioning of the sun. For example, the sun may occupy a morning position, during which time it continues to ascend after sunrise, moving towards its peak in the sky. For example, the sun may also be in a solar noon position, which is when it reaches its highest point in the sky. For example, additionally, the sun may take an afternoon position, a period characterized by its descent from the peak after solar noon but before it sets. For example, there may also be a sunset position, wherein the sun dismay comprise below the horizon in the evening. For example, the sun may also be in a dusk position, a period that occurs after sunset but before complete darkness sets in. For example, another position is the dawn position, which is the period before sunrise when light gradually starts to fill the sky. For example, the sun may also reach the zenith position, a point where it is directly overhead, a phenomenon that only occurs within the tropics, between the Tropic of Cancer and the Tropic of Capricorn. For example, the sun may also cross the equinox position, a point that occurs twice a year when the sun crosses the celestial equator and day and night have almost equal duration. For example, lastly, the sun may be at the solstice position, a point that happens twice a year when the sun is at its highest or lowest point in the sky at noon, marking the longest and the shortest days of the year.

In some instances, the environmental condition comprises a cloud coverage. For example, the cloud coverage may comprise few (e.g., ⅛ to 2/8 of the sky is covered by clouds), scattered (e.g., ⅜ to 4/8 of the sky is covered by clouds), broken (e.g., ⅝ to ⅞ of the sky is covered by clouds), overcast (e.g., the sky is entirely covered by clouds), partly cloudy/partly sunny (e.g., depending on the total sky cover and the time of day, these terms are used interchangeably to describe ⅜ to ⅝ cloud cover), or mostly cloudy/mostly sunny (e.g., these terms usually refer to 6/8 to ⅞ cloud cover). In further examples, the surface material may comprise a translucency of up to about 50% when the cloud cover is about 4/8 or greater.

In some instances, the environmental condition comprises a precipitation level (e.g., rain or snow). For example, the level of precipitation may comprise up to about 150 inches within 24 hours and the surface material may comprise a translucency of at most about 30%.

In some instances, the environmental condition comprises a temperature. For example, the temperature may comprise about 134° F. and the surface material may comprise a translucency of at least about 98%. For example, the temperature may comprise about 0° F. and the surface material may comprise a translucency of at most about 10%.

In some instances, the environmental condition comprises a time of day. For example, in the morning the surface material comprises a degree of translucency between about 30% to about 85%. In further examples, around noon-time the surface material may comprise a degree of translucency between about 70% to about 100%. In even further examples, at nighttime the surface material may comprises a maximum degree of translucency of about 30%.

FIG. 3C schematically illustrates how a surface material may utilize increased translucency to let more light pass through based on an environmental condition that (e.g., cloud coverage) may affect the amount of sunlight hitting a given environment. In the example of FIG. 3C, the system 300 may comprise a swarm of unmanned aerial vehicles 304 and a surface material 306. In FIG. 3C, the sun 302 is at its highest position in the day. Further, in FIG. 3C, the surface material 306 is positioned between the environment 308 and below the sun 302. Moreover, in FIG. 3C, the environmental condition comprises cloud coverage 310 positioned between the surface material 306 and the sun 302. For example, in FIG. 3C, the surface material 306 occludes the sunlight to a degree of translucency configured to permit a selected amount of sunlight. In further examples, in FIG. 3C, the surface material 306 configured for cloud coverage may comprise a maximum translucency less than a maximum translucency of a surface material 306 configured for an absence or lesser degree of cloud coverage (e.g., clear sky or clearer sky).

The payload may be configured to provide a selected degree of shade. In some cases, the degree of shade may comprise the total shaded area versus the total area of interest. In some instances, the total shaded area of the environment is divided by the total area of the environment to calculate the degree shade. For example, the degree of shade may comprise between about 0% to about 100% of the total area that is shaded.

In some cases, the degree of shade may comprise the total light intensity versus the light intensity reaching the environment. In some instances, the light intensity reaching the environment is divided by the total light intensity of the unfiltered sunlight to calculate the degree shade. In some instances, the light intensity is measured in lux, foot-candles, or similar units. For example, the degree of shade may comprise between about 0% to about 100% of the total light intensity that reaches the environment.

In some cases, the degree of shade may comprise the total solar radiation versus the solar radiation reaching the environment. In some instances, the solar radiation reaching the environment is divided by the total solar radiation of the unfiltered sunlight to infer the degree shade. In some instances, the solar radiation is Measured in watts per square meter (W/m²). For example, the degree of shade may comprise between about 0% to about 100% of the total solar radiation that reaches the environment.

In some examples, the payload may be configured to provide a degree of shade between about 0% to about 100%. In some examples, the payload may be configured to provide a degree of shade between about 0% to about 10%, about 0% to about 20%, about 0% to about 30%, about 0% to about 40%, about 0% to about 50%, about 0% to about 60%, about 0% to about 70%, about 0% to about 80%, about 0% to about 90%, about 0% to about 95%, about 0% to about 100%, about 10% to about 20%, about 10% to about 30%, about 10% to about 40%, about 10% to about 50%, about 10% to about 60%, about 10% to about 70%, about 10% to about 80%, about 10% to about 90%, about 10% to about 95%, about 10% to about 100%, about 20% to about 30%, about 20% to about 40%, about 20% to about 50%, about 20% to about 60%, about 20% to about 70%, about 20% to about 80%, about 20% to about 90%, about 20% to about 95%, about 20% to about 100%, about 30% to about 40%, about 30% to about 50%, about 30% to about 60%, about 30% to about 70%, about 30% to about 80%, about 30% to about 90%, about 30% to about 95%, about 30% to about 100%, about 40% to about 50%, about 40% to about 60%, about 40% to about 70%, about 40% to about 80%, about 40% to about 90%, about 40% to about 95%, about 40% to about 100%, about 50% to about 60%, about 50% to about 70%, about 50% to about 80%, about 50% to about 90%, about 50% to about 95%, about 50% to about 100%, about 60% to about 70%, about 60% to about 80%, about 60% to about 90%, about 60% to about 95%, about 60% to about 100%, about 70% to about 80%, about 70% to about 90%, about 70% to about 95%, about 70% to about 100%, about 80% to about 90%, about 80% to about 95%, about 80% to about 100%, about 90% to about 95%, about 90% to about 100%, or about 95% to about 100%. In some examples, the payload may be configured to provide a degree of shade between about 0%, about 10%, about 20%, about 30%, about 40%, about 50%, about 60%, about 70%, about 80%, about 90%, about 95%, or about 100%. In some examples, the payload may be configured to provide a degree of shade between at least about 0%, about 10%, about 20%, about 30%, about 40%, about 50%, about 60%, about 70%, about 80%, about 90%, or about 95%. In some examples, the payload may be configured to provide a degree of shade between at most about 10%, about 20%, about 30%, about 40%, about 50%, about 60%, about 70%, about 80%, about 90%, about 95%, or about 100%.

The payload may comprise a display. In some cases, the payload may comprise a display screen. In some instances, the display screen may comprise a Cathode Ray Tube (CRT), Liquid Crystal Display (LCD), Light Emitting Diode (LED), Organic Light Emitting Diode (OLED), Plasma Display Panel (PDP), Quantum Dot LED (QLED), E-Ink (Electronic Paper), MicroLED, Digital Light Processing (DLP), or a Liquid Crystal on Silicon (LCoS).

In some cases, the payload may comprise an audio system. In some instances, the audio system may comprise a mono system, a stereo system, a surround sound system, a multichannel audio system, a soundbar system, a PA (public address) system, a hi-fi (high fidelity) system, a wireless audio system, a car audio system, or a portable audio system.

In some cases, the payload may comprise a lighting system. In some instances, the lighting system may comprise incandescent light bulbs, fluorescent lights, compact fluorescent lamps (CFLs), LED lights, halogen lights, HID (high-intensity discharge) lights, neon lights, smart lighting systems, solar lights, or emergency lighting systems.

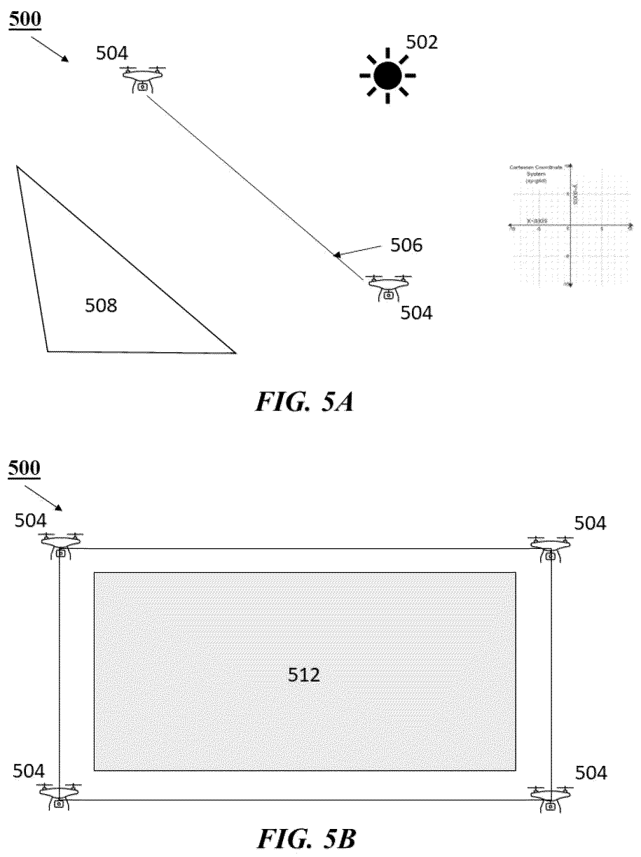

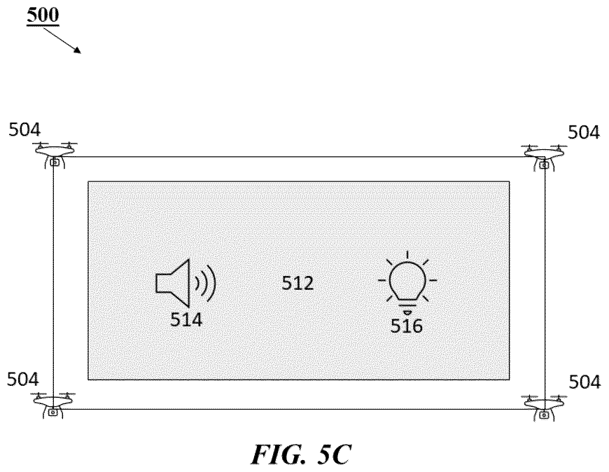

FIG. 5B schematically illustrates how a surface material may include a screen for displaying information to an audience (e.g., beneath the surface material). In some cases, the surface material may include a screen for displaying information to an audience beneath the surface material. In some cases, the surface material may include a screen for displaying information to an audience in front of the surface material. In some cases, the surface material may include a screen for displaying information to an audience above the surface material. In some cases, the surface material may include a screen for displaying information to an audience behind the surface material.

In the example of FIG. 5B, the system 500 comprises a swarm of UAVs 504 configured to hold a payload 512. In FIG. 5B, the payload 512 comprises a display screen. Further, the display screen 512 is positioned in front of an audience (not shown). Moreover, the swarm of UAVs 504 may position the display screen 512 in front of the audience (e.g., in the bleachers, box seats, etc.) via positioning at multiple elevations. In FIG. 5B, a first swarm of UAVs is positioned at a first elevation (e.g., the bottom corners of display screen 512) and a second swarm of UAVs is positioned at a second elevation (e.g., the top corners of display screen 512).

FIG. 5C schematically illustrates how a surface material may include a screen, sound and lighting systems. In FIG. 5C, the payload 512 comprises a display screen. Further, the display screen 512 is positioned in front of an audience (not shown). Moreover, the swarm of UAVs 504 may position the display screen 512 in front of the audience (e.g., in the bleachers, box seats, etc.) via positioning at multiple elevations. In FIG. 5C, a first swarm of UAVs is positioned at a first elevation (e.g., the bottom corners of display screen 512) and a second swarm of UAVs is positioned at a second elevation (e.g., the top corners of display screen 512).

Moreover, in FIG. 5C, the system 500 further comprises a sound system 514 and a lighting system 516. In some cases, the system 500 may comprise the sound system 514. In some instances, the swarm of UAVs 504 may comprise audio components configured to play the sound supplementing a display screen visual content. In some instances, the payload 512 may comprise audio components configured to play the sound supplementing a display screen visual content.

In some cases, the system 500 may comprise the lighting system 516. In some instances, the swarm of UAVs 504 may comprise lighting components configured to provide a light to supplement a display screen visual content. In some instances, the payload 512 may comprise lighting components configured to provide a light to supplement a display screen visual content. For example, the light may be configured for an audience to see the display screen visual content at night.

In some cases, the system 500 may comprise a first swarm of UAVs 504 configured to position the display screen 512 in front of an audience (not shown). In some cases, the system 500 may comprise a second set of UAVs 504 comprising the sound system 514 or lighting system 516. In some instances, the second set of UAVs 504 comprising the sound system 514 or lighting system 516 may be positioned closer to an audience member than the display screen 512.

In some cases, the system 500 may comprise a second swarm of UAVs 504 configured to provide a display screen visual content. In some instances, the second swarm of UAVs 504 configured to provide a display screen visual content may comprise a projector. For example, the projector may comprise one or more of a Liquid Crystal Display (LCD) Projector, Digital Light Processing (DLP) Projector, Liquid Crystal on Silicon (LCoS) Projector, Light Emitting Diode (LED) Projector, Laser Projector, or Cathode Ray Tube (CRT). In some instances, the second swarm of UAVs 504 may be configured to project the display screen visual content onto the display screen 512 (e.g., the display screen 512 is held in position by the first swarm of UAVs 504).

The SUAV may carry a payload. The payload may include a device capable of sensing the environment about the movable object, a device capable of emitting a signal into the environment, and/or a device capable of interacting with the environment.

One or more sensors may be provided as a payload and may be capable of sensing the environment. An example of a sensor may be a camera. Any other sensors, such as those described elsewhere herein may be provided as a payload.

In one example, the payload may be a camera. Any description herein of a camera may apply to any type of image capture device, and vice versa. A camera may be a physical imaging device. An imaging device may be configured to detect electromagnetic radiation (e.g., visible, infrared, and/or ultraviolet light) and generate image data based on the detected electromagnetic radiation. An imaging device may include an image sensor, such as a charge-coupled device (CCD) sensor or a complementary metal-oxide-semiconductor (CMOS) sensor that generates electrical signals in response to wavelengths of light. The resultant electrical signals may be processed to produce image data. The image data generated by an imaging device may include one or more images, which may be static images (e.g., photographs), dynamic images (e.g., video), or suitable combinations thereof. The image data may be polychromatic (e.g., RGB, CMYK, HSV) or monochromatic (e.g., grayscale, black-and-white, sepia). The imaging device may include a lens configured to direct light onto an image sensor.

The camera may be a movie or video camera that captures dynamic image data (e.g., video). A camera may be a still camera that captures static images (e.g., photographs). A camera may capture both dynamic image data and static images. A camera may switch between capturing dynamic image data and static images. Although certain embodiments provided herein are described in the context of cameras, it shall be understood that the present disclosure may be applied to any suitable imaging device, and any description herein relating to cameras may also be applied to any suitable imaging device, and any description herein relating to cameras may also be applied to other types of imaging devices. A camera may be used to generate 2D images of a 3D scene (e.g., an environment, one or more objects, etc.). The images generated by the camera may represent the projection of the 3D scene onto a 2D image plane. Accordingly, each point in the 2D image corresponds to a 3D spatial coordinate in the scene. The camera may comprise optical elements (e.g., lens, mirrors, filters, etc.). The camera may capture color images, greyscale image, infrared images, and the like.

The camera may capture an image or a sequence of images at a specific image resolution. In some embodiments, the image resolution may be defined by the number of pixels in an image. In some embodiments, the image resolution may be greater than or equal to about 352×420 pixels, 480×320 pixels, 720×480 pixels, 1280×720 pixels, 1440×1080 pixels, 1920×1080 pixels, 2048×1080 pixels, 3840×2160 pixels, 4096×2160 pixels, 7680×4320 pixels, or 15360×8640 pixels. In some embodiments, the camera may be a 4K camera or a camera with a higher resolution.

The camera may capture a sequence of images at a specific capture rate. In some embodiments, the sequence of images may be captured standard video frame rates such as about 24 p, 25 p, 30 p, 48 p, 50 p, 60 p, 72 p, 90 p, 100 p, 120 p, 300 p, 50 i, or 60 i. In some embodiments, the sequence of images may be captured at a rate less than or equal to about one image every 0.0001 seconds, 0.0002 seconds, 0.0005 seconds, 0.001 seconds, 0.002 seconds, 0.005 seconds, 0.01 seconds, 0.02 seconds, 0.05 seconds. 0.1 seconds, 0.2 seconds, 0.5 seconds, 1 second, 2 seconds, 5 seconds, or 10 seconds. In some embodiments, the capture rate may change depending on user input and/or external conditions (e.g. rain, snow, wind, unobvious surface texture of environment).

The camera may have adjustable parameters. Under differing parameters, different images may be captured by the imaging device while subject to identical external conditions (e.g., location, lighting). The adjustable parameter may comprise exposure (e.g., exposure time, shutter speed, aperture, film speed), gain, gamma, area of interest, binning/subsampling pixel clock, offset, triggering, ISO, etc. Parameters related to exposure may control the amount of light that reaches an image sensor in the imaging device. For example, shutter speed may control the amount of time light reaches an image sensor and aperture may control the amount of light that reaches the image sensor in a given time. Parameters related to gain may control the amplification of a signal from the optical sensor. ISO may control the level of sensitivity of the camera to available light. Parameters controlling for exposure and gain may be collectively considered and be referred to herein as EXPO.

One or more cameras supported by the UAV may have one or more of the same parameters, characteristics or features. In some instances, all of the cameras supported by the UAV may have the same characteristics or features. Alternatively, one or more of the cameras supported by the UAV may have different characteristics or features. In some instances, each of the cameras supported by the UAV may have different characteristics or features.

The one or more cameras may be supported by a UAV body. The one or more cameras may be supported on a central body of the UAV. The one or more cameras may or may not be supported on one or more arms of the UAV. The one or more cameras may be supported by a housing of the UAV. The one or more cameras may be attached to an external surface of the housing the UAV. The one or more cameras may be embedded within an external surface of the housing of the UAV. The one or more cameras may have an optical element, such as a lens, that may be exposed to an environment exterior to the UAV. The optical element may optionally be protected from an environment exterior to the UAV with aid of a cover. The cover may be transparent. The cover may or may not include an optical filter.

Any number of cameras may be provided. For instance, there may be 1 or more, 2 or more, 3 or more, 4 or more, 5 or more cameras supported by the UAV.

In some embodiments, each UAV monitors beneficial parameters like motor health, battery voltage, and communication status in real time. In some cases, if a UAV encounters a fault, neighboring UAVs automatically redistribute tension to prevent sudden payload drop. In some instances, the canopy includes segmented panels so that one section may be lowered or folded if its supporting UAVs fail. For example, a partial folding mechanism may activate to isolate the malfunctioning UAV's region, keeping the remainder aloft. As an example, an emergency descent sequence may also be initiated to gradually lower the entire canopy in a controlled fashion. In some instances, UAV-to-UAV communication ensures immediate detection of failures, triggering re-routing of load responsibilities. For example, a fallback path for data and commands may exist if the main communication relay is lost. As an example, these redundancy protocols help ensure continuous safety and functionality during large public events.

In some embodiments, the UAV swarm operates under a cloud-based management system that aggregates environmental data and swarm telemetry. In some cases, a central server or edge computing node runs an adaptive planning algorithm, updating UAV flight paths every few seconds. In some instances, multiple objectives—like maximizing shade, minimizing energy use, or aligning with sponsor branding—are balanced via optimization. For example, the system may shift sections of the canopy to display event logos while still preserving coverage over the field. As an example, the cloud engine may push real-time instructions to each UAV regarding altitude, lateral shifts, or translucency settings. In some instances, local failsafe modules on each UAV allow partial autonomy if cloud connection is lost. For example, the UAV may hold its last valid position or revert to a safe home location until connectivity is restored. As an example, combining centralized coordination with local autonomy helps the swarm remain robust under network disruptions.

The payload may include one or more devices capable of emitting a signal into an environment. In some cases, the payload may comprise an emitter along an electromagnetic spectrum (e.g., visible light emitter, ultraviolet emitter, infrared emitter). In some cases, the payload may include a laser or any other type of electromagnetic emitter. In some cases, the payload may emit one or more vibrations, such as ultrasonic signals. In some cases, the payload may emit audible sounds (e.g., from a speaker). The payload may emit wireless signals, such as radio signals or other types of signals.

In some cases, the payload may be capable of interacting with the environment. In some instances, the payload may include a robotic arm. In some cases, the payload may include an item for delivery, such as a liquid, gas, and/or solid component. In some instances, the payload may include pesticides, water, fertilizer, fire-repellant materials, food, packages, or any other item.

In some cases, the payload may be stationary relative to a UAV body. In some cases, the payload may be configured so that it does not move relative to the UAV body during operation of the UAV (e.g., flight of the UAV). In some cases, the payload may be configured so that it does not move relative to the UAV body during operation of the payload (e.g., capturing images by a camera). In some cases, the payload may be affixed relative to the UAV body.

The payload may be movable relative to a UAV body. In some cases, the payload may be configured so that it is capable of movement relative to the UAV body during operation of the UAV (e.g., flight of the UAV). In some cases, the payload may be configured so that the payload is capable of movement relative to the UAV body during operation of the payload (e.g., capturing images by a camera). In some cases, the payload may be supported with aid of one or more carriers or components that may provide the payload to move relative to the UAV body. In some instances, the payload may translate along one, two or three directions relative to the UAV body, or rotate about one, two, or three axes relative to the UAV body. For example, the carrier may permit a change in orientation of the payload relative to the UAV body. In further examples, the payload may be supported by a carrier having a gimbaled frame assembly. Any characteristics described elsewhere herein for a payload and a carrier may be applied. In some cases, the payload may be moved relative to the UAV body with aid of one or more actuators.

In some cases, the payload may be supported by the UAV body. In some instances, the payload may be supported by one or more arms of the UAV. In some instances, the payload may be beneath the UAV body. In some instances, the payload may be supported beneath a central body, above a central body, or on a side of a central body.

A payload may have a functional space. In some cases, the payload may be configured to perform a function or operation. In some instances, the function or operation of the payload may require a certain amount of functional space. The functional space may be, for example, a space occupied, affected, manipulated, or otherwise used by the payload during its operation. In some instances, however, the functional space may be obstructed by a portion of the transformable aerial vehicle. Any obstruction of a functional space may interfere with the operation of the payload. In one example, a functional space of the payload may include a sensing field of a payload. For example, when a payload is a camera, the functional space of the camera may be a field of view of the camera.

In some embodiments, there may be scenarios wherein it is not desirable to use the payload to provide shade. These instances may include times of complete cloud coverage, rain, or snow. In some instances the payload's shape and/or deployment location may be configured to block and collect any falling rain or snow. This may help to protect any people below the payload from the falling rain or snow. The payload may also be configured to perform any other of the functions disclosed herein when used for collecting falling rain or snow.

In some embodiments, the swarm of UAVs may be directed to transport the collected water from the rain or snow to a specified location. For example, the location may include a water storing location to store the collected water, a farm or other agricultural location to water the farm or agricultural location with the collected water, or a park or other private or public green space to water the park or private or public green space with the collected water. In some embodiments, a green space may be a location where it may be selected to drop the collected water to help grass, trees, bushes, and/or other foliage grow.

The system may comprise a non-transitory computer-readable storage media encoded with instructions. In some cases, the instructions may be executable by at least one processor to cause the at least one processor to perform operations. In some cases, the swarm of UAVs may comprise the at least one processor. For example, the processor may be onboard at least one UAV of the swarm of UAVs. In some cases, the swarm of UAVs may be in communication with the at least one processor. For example, the processor may be on a payload. In further examples, the processor may be at some other location external to the payload and the swarm of UAVs.

The operations may comprise connecting each UAV of the swarm to a plurality of connecting points of the payload. In some cases, the plurality of connection points comprise at least one location on at least one UAV of the swarm of UAVs where the at least one UAV connects to at least one payload. For example, a bottom surface of the at least one UAV may connect to at least one payload top surface.

In some cases, each UAV of the swarm may comprise UAV components configured to connect to at least one payload. In some instances, the UAV components configured to connect to the at least one payload may comprise one or more of a mounting bracket or harness, rope or cord, payload bay or compartment, gimbal, pin or clip, hook, adhesive, or magnetic attachment. In some instances, the UAV components configured to connect to the at least one payload may comprise a payload bay or mounting system. For example, the payload bay or mounting system may comprise a physical structure on at least one UAV of the swarm of UAVs where the at least payload is attached (e.g., for cameras, this often includes a gimbal system to stabilize the camera).

In some embodiments, each UAV includes specialized hooks, brackets, or magnetic couplings to attach to the payload. In some cases, each coupling mechanism comprises tension sensors or strain gauges to monitor applied force. In some instances, the UAVs share real-time load data over a swarm network to balance tension across the shading surface. For example, one UAV may detect excess strain and signal neighboring UAVs to adjust altitude or lateral position. As an example, the system may have a central controller that redistributes load if one UAV detects potential overextension in its tether. In some instances, these hooks or tethers may be retractable or motorized, providing automated engagement and disengagement. For example, the UAV may reel its tether in or out to reposition the payload without manual intervention. As an example, such a feature allows individual UAVs to detach for battery replacement while minimizing disturbance to the overall canopy.

In some cases, the swarm of UAVs is configured to collectively support and move the payload. In some instances, the swarm of UAVs is configured to support the payload by a distributed load. For example, the payload may be divided into smaller parts, and each UAV may carry a portion of the total payload (e.g., this may lighten the load for each individual drone). In some instances, the swarm of UAVs is configured to support the payload by a tethered configuration. For example, a large payload may be attached to multiple UAV via tethers, effectively spreading the weight of the payload across multiple UAV. In some instances, the swarm of UAVs is configured to support the payload by a stacked configuration. For example, the UAV may be stacked vertically with the payload attached to the bottom drone (e.g., the other UAV may provide additional lift and stability). In some instances, the swarm of UAVs is configured to support the payload by coordinated flight. For example, if the payload is not physically divided or attached to multiple UAV, the swarm of UAVs may support the payload-carrying drone by providing navigation, surveillance, or decoy services. In some instances, the swarm of UAVs is configured to support the payload by a relay system. For example, for long-distance delivery, a relay system may be set up where UAV hand off the payload to the next drone when their battery gets low.

In some embodiments, low-battery UAVs may be seamlessly replaced by fully charged UAVs without lowering the entire shading system. In some cases, a replacement UAV attaches to the payload and gradually provides a portion of the load before the depleted UAV detaches. In some instances, a central ground station stores multiple drones on quick-charge platforms so fresh UAVs are always available. For example, battery swapping may occur in a “handover zone” slightly offset from the main canopy, ensuring minimal payload movement. As an example, the depleted UAV may then automatically navigate to the charging station using precision landing technology. In some instances, the payload may include integrated photovoltaic cells that provide partial energy to UAV batteries mid-flight. For example, these cells may feed power into a common bus, from which connected UAVs draw incremental charging current. As an example, combining battery-swapping procedures and solar-assisted charging extends operational time significantly.

The payload may comprise a plurality of surface materials. In some cases, a first surface material and a second material may be joined together to form a shape. In some instances, the shape may comprise a 2.5D shape. For example, the 2.5D shape may comprise a half dome. In further examples, the 2.5D shape may comprise a light system, audio system, or a combination thereof.

In some cases, the plurality of surface materials may be joined together at the edges. In some instances, each surface material is carried/supported by a swarm of UAV. For example, the swarm of UAV may be acting in concert.

In some instances, each surface material may comprise multiple points of engagement for each UAV. For example, each surface material may comprise a matrix with hook-holes allowing UAV to latch on. In further examples, the shape of the surface material may be adjusted via manipulating an elevation of each UAV. In further examples, the shape of the surface material may be adjusted via manipulating a point of latching of each UAV.

In some instances, the UAV components configured to connect to the payload may comprise a control system. For example, the control system may be a part of the UAV's onboard computer system that allows the operator to control the payload (e.g., starting or stopping video recording, adjusting camera settings, or controlling other payload functions). In some instances, the UAV components configured to connect to the payload may comprise a data link. For example, the data link may provide the transmission of data between the payload and the ground control station (e.g., video feed, telemetry data, or other information). In some instances, the UAV components configured to connect to the payload may comprise a power supply. For example, the power supply may be the UAV's own power system that provides power to the payload. In some instances, a larger payloads may comprise their own independent power sources. In some instances, the UAV components configured to connect to the payload may comprise software/firmware. For example, the software/firmware may help in controlling, operating, and extracting data from the payload. For example, may be configured to integrate and operate the payload within the UAV.

The operations may comprise deploying the payload to a selected location. In some cases, the selected location may be above the environment. For example, the payload placed above the environment may provide a selected degree of shade to the environment. In some cases, the operations may comprise directing each UAV of the swarm to hover at a selected location. In some cases, the operations may comprise adjusting the selected location and/or the selected shape of the payload. In some instances, the operations may comprise tracking a trajectory of the sun. For example, the operations may comprise tracking a trajectory of the sun and adjusting the selected location of each UAV of the swarm (e.g., to follow the trajectory of the sun). In some cases, the selected location may be chosen based on one or more of sun light intensity, environmental condition, selected amount of shade, presence of a person (e.g., fan in a stadium), or pre-existing sun cover.

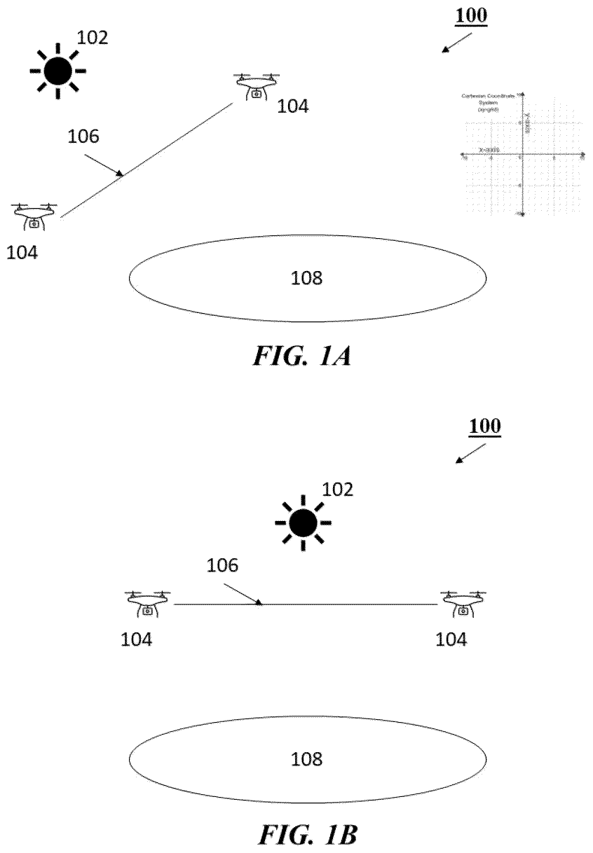

FIG. 1A-1C schematically illustrates a system for using unmanned aerial vehicles for providing shade to an environment by tracking a trajectory of the sun. FIG. 1A schematically illustrates a system for providing shade to an environment as the sun may be rising. The processor may be configured to instruct the swarm of UAVs 104 to deploy to a location. In some cases, the processor may be configured to instruct the swarm of UAVs 104 to adjust the selected location. In some instances, the processor may be configured to track a trajectory of the sun and instruct the swarm of UAVs 104 in accordance with the trajectory of the sun. In the example of FIG. 1A, a system 100 comprising a swarm of UAVs 104 and a surface material 106 is shown. In FIG. 1A, the trajectory of a sun 102 comprises the sun 102 rising (e.g., in between its lowest and highest points). Further, in the example of FIG. 1A, the system 100 tracked that the sun 102 was rising. In one example, in FIG. 1B, the processor tracked that the sun 102 was rising. In some examples, at least one sensor on at least one UAV of the swarm of UAVs 104 tracked that the sun was rising. In other examples, at least one device in communication with at least one processor of at least one UAV of the swarm of UAVs 104 tracked that the sun was rising. Moreover, in the example of FIG. 1A, the processor instructed the swarm of UAVs 104 to adjust their location to position themselves in a plurality of locations configured to position the surface material 106 to provide a selected amount of shade. Moreover, in the example of FIG. 1A, the swarm of UAVs 104 hold the surface material 106 at an angle. Further, in FIG. 1A, the angle may comprise about 45° (e.g., in either the negative X or positive X direction) with respect to an environment 108. In other examples, the angle may comprise between about 0° to about 360°.

In the example of FIG. 1A, the surface material 106 provides a selected amount of shade to substantially all of environment 108. In the example, of FIG. 1A, the selected shape of the surface material 106 may comprise a substantially flat surface material 106. In other examples, the surface material 106 may comprise any other selected shape.

FIG. 1B schematically illustrates a system for providing shade to an environment as the sun may be at its highest point in a day. In the example of FIG. 1B, a system 100 comprising a swarm of UAVs 104 and a surface material 106 is shown. In FIG. 1B, the trajectory of a sun 102 comprises the sun 102 is at its highest point. Further, in the example of FIG. 1B, the system 100 tracked that the sun 102 was at its highest point. In one example, in FIG. 1B, the processor tracked that the sun 102 was at its highest point. In some examples, at least one sensor on at least one UAV of the swarm of UAVs 104 tracked that the sun was at its highest point. In other examples, at least one device in communication with at least one processor of at least one UAV of the swarm of UAVs 104 tracked that the sun was at its highest point. Moreover, in the example of FIG. 1B, the processor instructed the swarm of UAVs 104 to adjust their location to position themselves in a plurality of locations configured to position the surface material 106 to provide a selected amount of shade. Moreover, in the example of FIG. 1B, the swarm of UAVs 104 hold the surface material 106 at a location between the sun 102 and the environment 108. In the example of FIG. 1B, the surface material 106 provides a selected amount of shade to substantially all of environment 108. In the example, of FIG. 1B, the selected shape of the surface material may comprise a substantially flat surface material 106. In other examples, the surface material 106 may comprise any other selected shape.

FIG. 1C schematically illustrates a system for providing shade to an environment as the sun may be setting. In the example of FIG. 1C, a system 100 comprising a swarm of UAVs 104 and a surface material 106 is shown. In FIG. 1C, the trajectory of a sun 102 comprises the sun 102 setting (e.g., in between its highest and lowest points). Further, in the example of FIG. 1C, the system 100 tracked that the sun 102 was setting. In one example, in FIG. 1C, the processor tracked that the sun 102 was setting. In some examples, at least one sensor on at least one UAV of the swarm of UAVs 104 tracked that the sun was setting. In other examples, at least one device in communication with at least one processor of at least one UAV of the swarm of UAVs 104 tracked that the sun was setting. Moreover, in the example of FIG. 1C, the processor instructed the swarm of UAVs 104 to adjust their location to position themselves in a plurality of locations configured to position the surface material 106 to provide a selected amount of shade. Moreover, in the example of FIG. 1C, the swarm of UAVs 104 hold the surface material 106 at an angle. Further, in FIG. 1C, the angle may comprise about 45° (e.g., in either the negative X or positive X direction) with respect to an environment 108. In other examples, the angle may comprise between about 0° to about 360°. In the example of FIG. 1C, the surface material 106 provides a selected amount of shade to substantially all of environment 108. In the example, of FIG. 1C, the selected shape of the surface material may comprise a substantially flat surface material 106. In other examples, the surface material 106 may comprise any other selected shape.

The operations may comprise deploying the payload at a selected shape. In some cases, the selected shape may comprise a shape configured to provide a selected degree of shade to the environment. In some cases, the operations may comprise adjusting the selected shape of the payload. In some cases, the operations may comprise tracking a trajectory of the sun. In some instances, the operations may comprise tracking a trajectory of the sun and adjusting the selected shape. For example, the operations may comprise adjusting an elevation or location of each UAV of the swarm, thereby adjusting the selected shape of the payload.

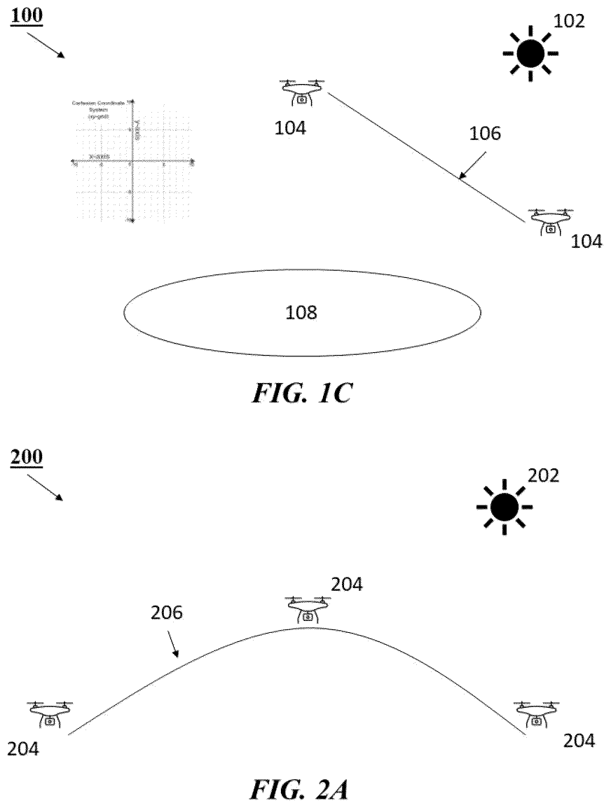

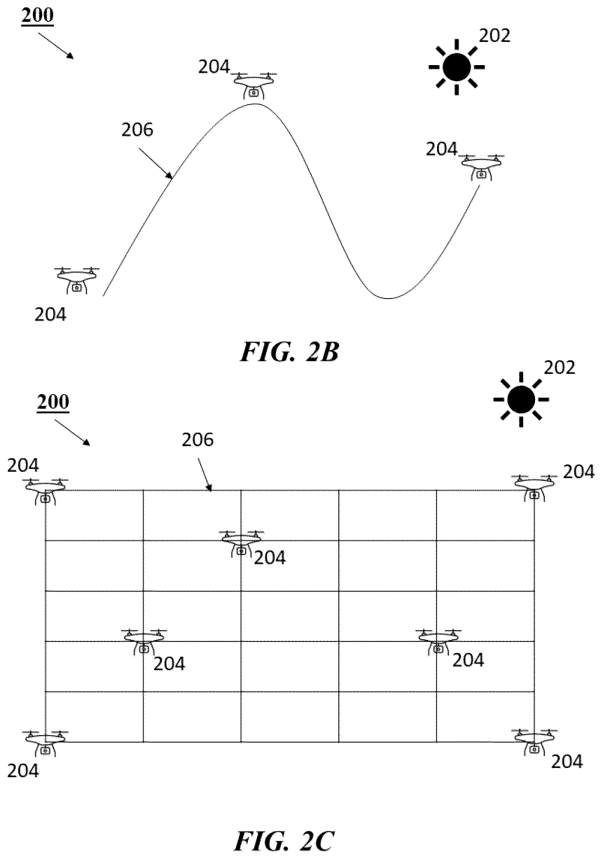

FIG. 2A-2C schematically illustrate how the unmanned aerial vehicles may alter the shape of a surface material used for providing shade to an environment. FIG. 2A schematically illustrates the unmanned aerial vehicles holding a surface material in an inverted U-shape. The processor may be configured to instruct the swarm of UAVs 204 to deploy the payload 206 at a selected shape. In the example of FIG. 2A, a system 200 comprising a swarm of UAVs 204 and a surface material 206 is shown. In some cases, the swarm of UAVs 204 may deploy payload 206 at a selected shape to provide a selected degree of shade. In some instances, the selected shape may comprise an inverted U-shape payload 206. For example, the swarm of UAVs 204 may comprise a first swarm of UAVs 204 and a second swarm of UAVs 204. In FIG. 2A, the first swarm of UAVs 204 are located at a first elevation and the second swarm of UAVs 204 are located at a second elevation. Moreover, the second elevation is higher than the first elevation, thereby deploying the surface material 206 at the inverted U-shape. Furthermore, the surface material 206 may provide a selected degree of shade. For example, the surface material may comprise a degree of translucency between about 0% to about 99%. In the example of FIG. 2A, the surface material 206 provides a selected amount of shade to substantially all of the environment.

In some cases, the processor may be configured to instruct the swarm of UAVs 204 to adjust the payload 206 to a selected shape. In some instances, the system may be configured to track a trajectory of the sun and instruct the swarm of UAVs 204 (e.g., via the processor) in accordance with the trajectory of the sun. In FIG. 2A, the trajectory of a sun 202 comprises the sun 202 setting (e.g., in between its highest and lowest points). Further, in the example of FIG. 2A, the system 200 tracked that the sun 202 was rising. Moreover, in the example of FIG. 2A, the processor instructed the swarm of UAVs 204 to adjust their location to position themselves in a plurality of locations configured to position the surface material 206 to provide a selected shape. Moreover, in the example of FIG. 2A, each UAV in the swarm of UAVs 204 hold the surface material 206 at similar or different elevations. Further, in FIG. 2A, the surface material 206 may comprise an inverted U-shape.

FIG. 2B schematically illustrates how the unmanned aerial vehicles may hold multiple points of surface material at different elevations. In the example of FIG. 2B, a system 200 comprising a swarm of UAVs 204 and a surface material 206 is shown. In some cases, the swarm of UAVs 204 may deploy payload 206 at a selected shape to provide a selected degree of shade. In some instances, the selected shape may comprise a payload 206 comprising a wave-like shape (e.g., a sinusoidal wave). For example, the surface material may comprise a degree of translucency between about 0% to about 99%. In the example of FIG. 2B, the surface material 206 provides a selected amount of shade to substantially all of the environment.

In some cases, the processor may be configured to instruct the swarm of UAVs 204 to adjust the payload 206 to a selected shape. In some instances, the processor may be configured to track a trajectory of the sun and instruct the swarm of UAVs 204 in accordance with the trajectory of the sun. In FIG. 2B, the trajectory of a sun 202 comprises the sun 202 setting (e.g., in between its highest and lowest points. Further, in the example of FIG. 2B, the system 200 tracked that the sun 202 was setting. Moreover, in the example of FIG. 2B, the processor instructed the swarm of UAVs 204 to adjust their location to position themselves in a plurality of locations configured to position the surface material 206 to provide a selected shape. Moreover, in the example of FIG. 2B, each UAV in the swarm of UAVs 204 hold the surface material 206 at different elevations. Further, in FIG. 2B, the surface material 206 may comprise a wave-like shape (e.g., a sinusoidal wave).

FIG. 2C schematically illustrates how the surface material may include a plurality of connecting points for the unmanned aerial vehicles, allowing the UAV devices to create of plurality of two dimensional (2D) shapes of the surface material. In the example of FIG. 2C, a system 200 comprising a swarm of UAVs 204 and a surface material 206 is shown. In some cases, the swarm of UA Vs 204 may deploy payload 206 at a selected shape to provide a selected degree of shade. In some instances, the selected shape may comprise a payload 206 comprising a plurality of 2D shapes. For example, the 2D shape may comprise a polygon. In further examples, the 2D shape may comprise one or more of a circle, an oval or ellipse, a triangle (which may be further classified as equilateral, isosceles, scalene, or right), a quadrilateral (e.g., including rectangle, square, rhombus, parallelogram, and trapezoid), a pentagon, a hexagon, a heptagon, an octagon, a nonagon, or a decagon. In further examples, the 2D shape may comprise one or more of an inverted circle, an inverted oval or ellipse, an inverted triangle (e.g., which may be further classified as inverted equilateral, inverted isosceles, inverted scalene, or inverted right), an inverted quadrilateral (e.g., including inverted rectangle, inverted square, inverted rhombus, inverted parallelogram, and inverted trapezoid), an inverted pentagon, an inverted hexagon, an inverted heptagon, an inverted octagon, an inverted nonagon, or an inverted decagon. In further examples, the 2D shape may comprise an A-shape or an inverted A-shape, a B-shape or an inverted B-shape, a C-shape or an inverted C-shape, a D-shape or an inverted D-shape, an E-shape or an inverted E-shape, an F-shape or an inverted F-shape, a G-shape or an inverted G-shape, an H-shape or an inverted H-shape, an I-shape or an inverted I-shape, a J-shape or an inverted J-shape, a K-shape or an inverted K-shape, an L-shape or an inverted L-shape, a M-shape or an inverted M-shape, an N-shape or an inverted N-shape, an O-shape or an inverted O-shape, a P-shape or an inverted P-shape, a Q-shape or an inverted Q-shape, an R-shape or an inverted R-shape, an S-shape or an inverted S-shape, a T-shape or an inverted T-shape, a U-shape or an inverted U-shape, a V-shape or an inverted V-shape, a W-shape or an inverted W-shape, an X-shape or an inverted X-shape, a Y-shape or an inverted Y-shape, or a Z-shape or an inverted Z-shape.

For example, the surface material may comprise a degree of translucency between about 0% to about 99%. In the example of FIG. 2C, the surface material 206 provides a selected amount of shade to substantially all of the environment.

In some cases, the processor may be configured to instruct the swarm of UAVs 204 to adjust the payload 206 to a selected shape. In some instances, the system 200 may be configured to track a trajectory of the sun and instruct the swarm of UAVs 204 in accordance with the trajectory of the sun. In FIG. 2C, the trajectory of a sun 202 comprises the sun 202 setting (e.g., in between its highest and lowest points. Further, in the example of FIG. 2C, the system 200 tracked that the sun 202 was setting. Moreover, in the example of FIG. 2C, the processor instructed the swarm of UAVs 204 to adjust their location to position themselves in a plurality of locations configured to position the surface material 206 to provide a selected shape. Moreover, in the example of FIG. 2A, each UAV in the swarm of UAVs 204 hold the surface material 206 at both similar and different elevations. Further, in FIG. 2C, the surface material 206 may comprise a plurality of 2D shapes.

The operations may comprise the system deploying a plurality of payloads above the environment. In some cases, processor may be configured to instruct the swarm of UAVs to deploy a plurality of payloads above the environment.

In some instances, the processor may be configured to instruct the swarm of UAVs to position the plurality of payloads together. For example, the positioning the plurality of payloads together may be configured to provide an increased selected degree of shade to the environment. For example, the degree of shade may comprise between 0% to about 100% of total area coverage.

In some instances, the positioning the plurality of payloads together is configured to cover an entire environment. In some instances, the positioning the plurality of payloads together is configured to cover a portion of an environment. For example, the positioning the plurality of payloads may cover between about 1% to about 100% of the environment.

In some cases, the processor may be configured to instruct the swarm of UAVs to deploy the plurality of payloads at a plurality of individual selected locations. In some instances, the deploying the plurality of payloads at a plurality of individual selected locations is configured to provide a degree of shade to a plurality of locations of the environment. For example, the plurality of individual selected locations may comprise a plurality of individual locations affected with sunlight.

FIG. 4 schematically illustrates how multiple unmanned drone systems may be utilized to hold up multiple surface materials above a given environment. In the example of FIG. 4, a system 400 comprising a swarm of UAVs 404 and multiple surface materials 406 is shown. Further, in the example of FIG. 4, the processor instructed a first swarm of UAVs 404 to deploy a first payload 406a at a selected location and selected shape. Moreover, in the example of FIG. 4, the processor instructed a second swarm of UAVs 404 to deploy a second payload 406b at a selected location and selected shape. Moreover, in the example of FIG. 4, the first swarm of UAVs 404 hold the first payload 406a above an environment 408. Further, in the example of FIG. 4, the second swarm of UAVs 404 hold the second payload 406b above the environment 408. In further examples, the swarm of UAVs 404 are configured to connect the first payload 406a and the second payload 406b to cover substantially all of environment 408. In other examples, the swarm of UAVs 404 are configured to connect the first payload 406a and the second payload 406b to cover only a portion of environment 408 (e.g., some of environment 408 may already have shade, some of environment 408 may be unoccupied, etc.).

The operations may comprise customizing the content of the display screen, audio system, and/or lighting system to an event being held in the environment (e.g., a sporting event). In some cases, the environment comprises a stadium. In some instances, the environment comprises seating in the stadium. In some instances, the environment comprises the playing field of the stadium. In some cases, the content is configured for the environment. In some instances, the content is configured for the stadium. For example, the content may comprise a live audio and visual display (e.g., a close up) of the live stadium event (e.g., sporting event).

The operations may comprise deploying the payload at a selected angle. In some cases, the operations may comprise directing the swarm of UAVs to hold the payload at an angle. In some instances, the angle of the payload may match an angle of an environment. For example, the angle of the payload may match an angle of seating in the stadium.

The processor may be configured to instruct the swarm of UAVs to hold a surface material at an angle. In some cases, the swarm of UAVs holds the surface material at an angle that matches an angle of the environment. In some instances, the angle matches the incline of environment. For example, the angle/incline of the surface material may match the angle/incline of a stadium seating.

In some instances, the swarm of UAVs holds the surface material at the angle which matches the angle of the environment, wherein the angle comprises between about 0° to about 360°. In some instances, the swarm of UAVs holds the surface material at the angle which matches the angle of the environment, wherein the angle comprises between about 0° to about 45°, about 0° to about 90°, about 0° to about 120°, about 0° to about 150°, about 0° to about 180°, about 0° to about 210°, about 0° to about 240°, about 0° to about 270°, about 0° to about 300°, about 0° to about 330°, about 0° to about 360°, about 45° to about 90°, about 45° to about 120°, about 45° to about 150°, about 45° to about 180°, about 45° to about 210°, about 45° to about 240°, about 45° to about 270°, about 45° to about 300°, about 45° to about 330°, about 45° to about 360°, about 90° to about 120°, about 90° to about 150°, about 90° to about 180°, about 90° to about 210°, about 90° to about 240°, about 90° to about 270°, about 90° to about 300°, about 90° to about 330°, about 90° to about 360°, about 120° to about 150°, about 120° to about 180°, about 120° to about 210°, about 120° to about 240°, about 120° to about 270°, about 120° to about 300°, about 120° to about 330°, about 120° to about 360°, about 150° to about 180°, about 150° to about 210°, about 150° to about 240°, about 150° to about 270°, about 150° to about 300°, about 150° to about 330°, about 150° to about 360°, about 180° to about 210°, about 180° to about 240°, about 180° to about 270°, about 180° to about 300°, about 180° to about 330°, about 180° to about 360°, about 210° to about 240°, about 210° to about 270°, about 210° to about 300°, about 210° to about 330°, about 210° to about 360°, about 240° to about 270°, about 240° to about 300°, about 240° to about 330°, about 240° to about 360°, about 270° to about 300°, about 270° to about 330°, about 270° to about 360°, about 300° to about 330°, about 300° to about 360°, or about 330° to about 360°. In some instances, the swarm of UAVs holds the surface material at the angle which matches the angle of the environment, wherein the angle comprises between about 0°, about 45°, about 90°, about 120°, about 150°, about 180°, about 210°, about 240°, about 270°, about 300°, about 330°, or about 360°. In some instances, the swarm of UAVs holds the surface material at the angle which matches the angle of the environment, wherein the angle comprises between at least about 0°, about 45°, about 90°, about 120°, about 150°, about 180°, about 210°, about 240°, about 270°, about 300°, or about 330°. In some instances, the swarm of UAVs holds the surface material at the angle which matches the angle of the environment, wherein the angle comprises between at most about 45°, about 90°, about 120°, about 150°, about 180°, about 210°, about 240°, about 270°, about 300°, about 330°, or about 360°.

FIG. 5A schematically illustrates how the unmanned aerial vehicles may hold a surface material at an angle that matches an angle of the environment. In the example of FIG. 5A, a swarm of UAVs 504 holds a surface material 506 at an angle. Further, in FIG. 5A, the environment 508 may comprise an angle of about 45° (e.g., in either the negative X or positive X direction) with respect to match the angle of the environment 508. In the example of FIG. 5A, the surface material 506 provides shade to substantially all of environment 508. In other examples, the swarm of UAVs 504 may be positioned to provide shade to a portion of environment 508 (e.g., if environment 508 is partially unoccupied or has pre-existing shade for example). Moreover, in the example of FIG. 5A, the swarm of UAVs 504 comprise a first swarm of UAVs 504 and a second swarm of UAVs 504. Further, the second swarm of UAVs 504 comprise a higher elevation than the first swarm of UAVs 504. Moreover, the second swarm of UAVs 504 are connected to an end of the surface material 506 opposite the end of the surface material 1506 of where the first swarm of UAVs 504 are connected. Further, the second swarm of UAVs 504 comprise about a 45° with respect to the first swarm of UAVs 504.

The operations may comprise adjusting a degree of translucency. In some cases, the system is configured to adjust a degree of translucency. In some instances, the system may be configured to adjusting the degree of translucency based at least in part on an environmental condition. For example, the environmental condition may comprise an increased sun light intensity and the system may increase the degree of translucency.

In some cases, the adjusting the degree of translucency may comprise the processor instructing the swarm of UAVs to adjust one or more of a surface material angle, shape, or location. In some cases, the adjusting the degree of translucency may comprise the processor instructing the swarm of UAVs to switch a first surface material with a second surface material. In some instances, the first surface material and the second material may comprise a different material. For example, the second surface material may comprise an increased or decreased translucency than a translucency of the first surface material.

The operations may comprise switching out one or more UAVs of the swarm. In some cases, the operations may comprise switching out one or more UAVs of the swarm as a battery level of one or more UAVs of the swarm reaches a drained state. In some instances, the operations may comprise switching out one or more UAVs of the swarm with one or more newly charged UAVs from a charging station. In some instances, the operations may comprise a second swarm of UAVs replacing a battery on the first swarm of UAVs. In some instances, the operations may comprise a second swarm of UAVs charging the first swarm of UAVs. For example, the second swarm of UAVs may position themselves within charging distance of the first swarm of UAVs. In further examples, the second swarm of UAVs is configured to charge the first swarm of UAVs such that the surface material does not move substantially.

The processor may be configured to instruct the swarm of UA Vs to switch out one or more UAVs of the swarm. In some cases, the processor may be configured to instruct the swarm of UAVs to switch out one or more UAVs of the swarm as a battery level of one or more UAVs of the swarm reaches a drained state. In some instances, he processor may be configured to instruct the swarm of UAVs to switch out one or more UAVs of the swarm with one or more newly charged UAVs from a charging station. For example the swarm of UAVs may comprise a first swarm of UAVs and the newly charged UAVs may comprise a second swarm of UAVs.

The swarm of UAVs may comprise an extended battery life. In some cases, the battery life may comprise at least about 20 minutes. The swarm of UAVs may be configured to be charged rapidly. In some cases, the swarm of UAVs is configured to be charged at greater than or equal to 180W. In some instances, the swarm of UAVs is configured to be charged to full capacity within 90 minutes or less.

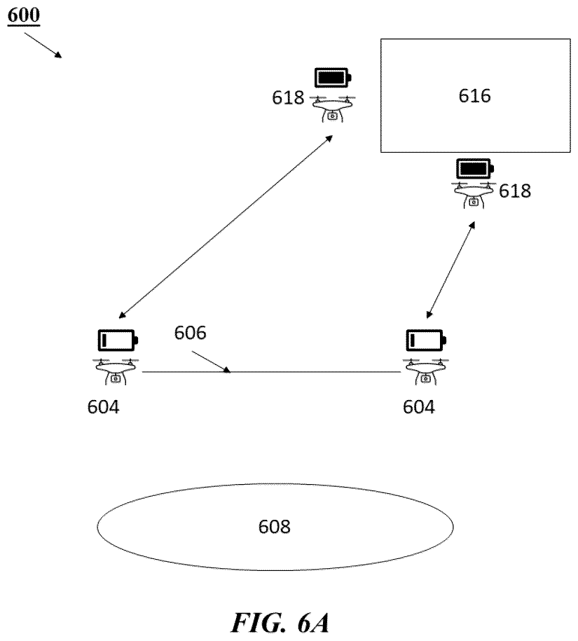

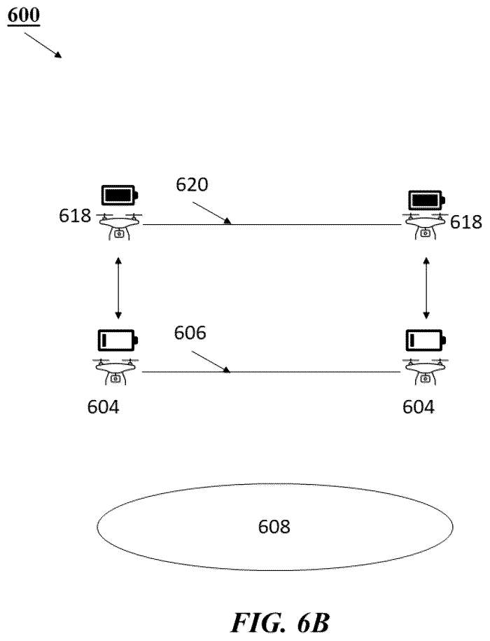

FIG. 6A-FIG. 6B schematically illustrate how fully charged unmanned aerial vehicles may be used to switch out unmanned aerial vehicles on low battery. FIG. 6A schematically illustrates how fully charged unmanned aerial vehicles from a docking station may be used to switch out low battery drone devices holding up a surface material, such that the surface material never need be lowered. In the example of FIG. 6A, a first swarm of UAVs 604 held a payload 616. Further, in the example of FIG. 6A, the first swarm of UAVs 604 held the payload 616 for substantially all of its battery life. Moreover, in the example of FIG. 6A, prior to an expiration of a first swarm of UAVs 604 battery life, a second swarm of UAVs 618 replaced the first swarm of UAVs 604. In FIG. 6A, the second swarm of UAVs 618 comprises a substantially fully charged battery (e.g., a substantially all of its full capacity). Moreover, in FIG. 6A, the second swarm of UAVs 618 replaced the first swarm of UAVs 604 without substantially raising or lowering the payload 616. In some instances, all of the first swarm of UAVs is replaced by a fully charged second swarm. In some instances, any number of UAVs (e.g., 1, 2, 3, 4, 5, 6, 7, 8, 9, or 10 UAVs) of the first swarm may be replaced by a same number of new fully charged UAVs.

In some cases, the second swarm of UAVs is configured to replace the first swarm of UAVs by positioning themselves adjacent to the first swarm of UAVs. In some instances, the second swarm of UAVs position themselves horizontally, vertically, or parallel adjacent to the first swarm of UAVs. For example, once the second swarm of UAVs is positioned to hold the payload the first swarm of UAVs may release the payload and return to a charging station. In some instances, a plurality of UAVs of the second swarm of UAVs position themselves next to each UAV in the first swarm of UAVs. For example, one UAV of the second swarm of UAVs may position itself to the left of a UAV of the first swarm of UAVs and another UAV of the second swarm of UAVs may position itself to the right of a UAV of the first swarm of UAVs. In further examples, after two UAVs of the second swarm are attached to the payload, the first UAV may return to the charging station. In even further examples, one of the UAVs of the second swarm of UAVs may release the payload (e.g., while the other remains attached).

In some cases, the surface material is never dropped. In some cases, the surface material is never substantially lowered. In some cases, the surface material is lowered to a selected elevation. In some cases, the surface material is raised to a selected elevation. In some cases, the surface material is shifted (e.g., to the left/right or forward/backward) to a selected location.

FIG. 6B schematically illustrates how a fully charged unmanned aerial vehicle and surface material system may beused to switch out a low battery drone device and surface material system. In the example of FIG. 6B, the system 600 comprises a first swarm of UAVs 604 and a first surface material 606. Further in FIG. 6B, the system 600 comprises a second swarm of UAVs 618 and a second surface material 620. In FIG. 6B, the second swarm of UAVs 618 with the second surface material 620 may replace the first swarm of UAVs 604 with the first surface material 606. In further examples, the second surface material 620 is a same surface material as the first surface material 606. In other examples, the second surface material 620 is a different surface material than the first surface material 606.

In some instances, the UAVs discussed herein may include one or more photovoltaic cells for converting thermal or solar energy into electricity. In some embodiments, the photovoltaic cells may be housed in one or more photovoltaic or solar panels. The photovoltaic cells may allow the UAVs discussed herein the opportunity to recharge and remain deployed without the need for powering down, recharging at a charging location (e.g., docking station), switching out for newly charged UAVs, or moving/switching out the deployed payload. In some embodiments, the UAVs may include one or more photovoltaic cells and may also be configured to recharge at a charging location (e.g., docking station) and/or be replaced with newly charged UAVs when deployed. In some embodiments, the UAVs may immediately convert the thermal or solar energy to electricity. In some embodiments, the UAVs may include one or more batteries configured for storing electricity produced by the photovoltaic cells. In some embodiments, the one or more batteries may be the same as, or in addition to, the existing batteries on the UAVs used for powering the UAVs. As has been discussed herein, the UAVs may also derive power from one or more photovoltaic cells included on the payload.

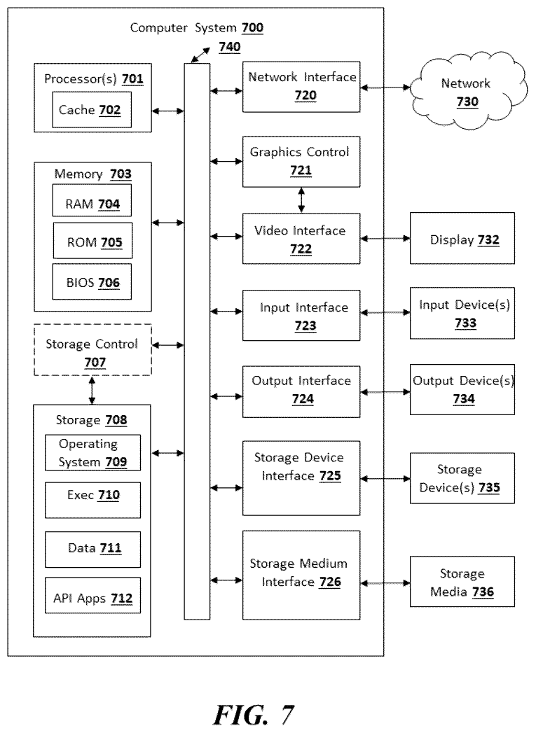

FIG. 7 shows a non-limiting example of a computing device; in this case, a device with one or more processors, memory, storage, and a network interface. Referring to FIG. 7, a block diagram is shown depicting an exemplary machine that includes a computer system 700 (e.g., a processing or computing system) within which a set of instructions may execute for causing a device to perform or execute any one or more of the aspects and/or methodologies for static code scheduling of the present disclosure. For example, the instructions may include flight directions for the UAVs discussed herein, as well as instructions for a swarm of UAVs to carry and deploy the payloads discussed herein. The components in FIG. 7 are examples only and do not limit the scope of use or functionality of any hardware, software, embedded logic component, or a combination of two or more such components implementing particular embodiments.

Computer system 700 may include one or more processors 701, a memory 703, and a storage 708 that communicate with each other, and with other components, via a bus 740. The bus 740 may also link a display 732, one or more input devices 733 (which may, for example, include a keypad, a keyboard, a mouse, a stylus, etc.), one or more output devices 12312, one or more storage devices 735, and various tangible storage media 736. All of these elements may interface directly or via one or more interfaces or adaptors to the bus 740. For instance, the various tangible storage media 736 may interface with the bus 740 via storage medium interface 726. Computer system 700 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 700 includes one or more processor(s) 701 (e.g., central processing units (CPUs), general purpose graphics processing units (GPGPUs), or quantum processing units (QPUs)) that carry out functions. Processor(s) 701 optionally contains a cache memory unit 702 for temporary local storage of instructions, data, or computer addresses. Processor(s) 701 are configured to assist in execution of computer readable instructions. Computer system 700 may provide functionality for the components depicted in FIG. 7 as a result of the processor(s) 701 executing non-transitory, processor-executable instructions embodied in one or more tangible computer-readable storage media, such as memory 703, storage 708, storage devices 735, and/or storage medium 736. The computer-readable media may store software that implements particular embodiments, and processor(s) 701 may execute the software. Memory 703 may read the software from one or more other computer-readable media (such as mass storage device(s) 735, 736) or from one or more other sources through a suitable interface, such as network interface 720. The software may cause processor(s) 701 to carry out one or more processes or one or more steps of one or more processes described or illustrated herein. As an example, the processes may include flight instructions for the UAVs discussed herein, as well as instructions for a swarm of UAVs to carry and deploy the payloads discussed herein. Carrying out such processes or steps may include defining data structures stored in memory 703 and modifying the data structures as directed by the software.

The memory 703 may include various components (e.g., machine readable media) including, but not limited to, a random access memory component (e.g., RAM 704) (e.g., static RAM (SRAM), dynamic RAM (DRAM), ferroelectric random access memory (FRAM), phase-change random access memory (PRAM), etc.), a read-only memory component (e.g., ROM 705), and any combinations thereof. ROM 705 may act to communicate data and instructions unidirectionally to processor(s) 701, and RAM 704 may act to communicate data and instructions bidirectionally with processor(s) 701. ROM 705 and RAM 704 may include any suitable tangible computer-readable media described below. In one example, a basic input/output system 706 (BIOS), including basic routines that help to transfer information between elements within computer system 700, such as during start-up, may be stored in the memory 703.

Fixed storage 708 is connected bidirectionally to processor(s) 701, optionally through storage control unit 707. Fixed storage 708 provides additional data storage capacity and may also include any suitable tangible computer-readable media described herein. Storage 708 may be used to store operating system 709, executable(s) 710, data 711, applications 712 (application programs), and the like. Storage 708 may also include an optical disk drive, a solid-state memory device (e.g., flash-based systems), or a combination of any of the above. Information in storage 708 may, in appropriate cases, be incorporated as virtual memory in memory 703.

In one example, storage device(s) 735 may be removably interfaced with computer system 700 (e.g., via an external port connector (not shown)) via a storage device interface 725. Particularly, storage device(s) 735 and an associated machine-readable medium may provide non-volatile and/or volatile storage of machine-readable instructions, data structures, program modules, and/or other data for the computer system 700. In one example, software may reside, completely or partially, within a machine-readable medium on storage device(s) 735. In another example, software may reside, completely or partially, within processor(s) 701.

Bus 740 connects a wide variety of subsystems. Herein, reference to a bus may encompass one or more digital signal lines serving a common function, where appropriate. Bus 740 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 700 may also include an input device 733. In one example, a user of computer system 700 may enter commands and/or other information into computer system 700 via input device(s) 733. Examples of an input device(s) 733 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 733 may be interfaced to bus 740 via any of a variety of input interfaces 723 (e.g., input interface 723) including, but not limited to, serial, parallel, game port, USB, FIREWIRE, THUNDERBOLT, or any combination of the above.

In particular embodiments, when computer system 700 is connected to network 730, computer system 700 may communicate with other devices, specifically mobile devices and enterprise systems, distributed computing systems, cloud storage systems, cloud computing systems, and the like, connected to network 730. Communications to and from computer system 700 may be sent through network interface 720. For example, network interface 720 may receive incoming communications (such as requests or responses from other devices) in the form of one or more packets (such as Internet Protocol (IP) packets) from network 730, and computer system 700 may store the incoming communications in memory 703 for processing. Computer system 700 may similarly store outgoing communications (such as requests or responses to other devices) in the form of one or more packets in memory 703 and communicated to network 730 from network interface 720. Processor(s) 701 may access these communication packets stored in memory 703 for processing.

Examples of the network interface 720 include, but are not limited to, a network interface card, a modem, and any combination thereof. Examples of a network 730 or network segment 730 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 730, may employ a wired and/or a wireless mode of communication. In general, any network topology may be used.

Information and data may be displayed through a display 732. Examples of a display 732 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 732 may interface to the processor(s) 701, memory 703, and fixed storage 708, as well as other devices, such as input device(s) 733, via the bus 740. The display 732 is linked to the bus 740 via a video interface 722, and transport of data between the display 732 and the bus 740 may be controlled via the graphics control 721. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 732, computer system 700 may include one or more other peripheral output devices 734 including, but not limited to, an audio speaker, a printer, a storage device, and any combinations thereof. Such peripheral output devices may be connected to the bus 740 via an output interface 724. Examples of an output interface 724 include, but are not limited to, a serial port, a parallel connection, a USB port, a FIREWIRE port, a THUNDERBOLT port, and any combinations thereof.

In addition or as an alternative, computer system 700 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof configured to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle®, Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Sony® PS5®, Microsoft® Xbox 360®, Microsoft® Xbox One, Microsoft® Xbox Series X, Microsoft® Xbox Series S, Nintendo® Wii®, Nintendo® Wii U®, Nintendo® Switch™M, and Ouya®.

Another aspect of the disclosure herein describes a non-transitory, computer-readable medium comprising executable instructions, wherein when a processor, when executing the executable instructions, performs a method as described herein.

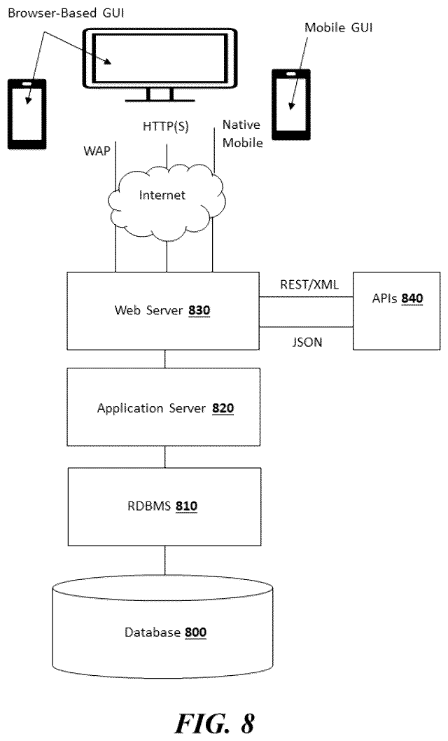

FIG. 8 shows a non-limiting example of a web/mobile application provision system; in this case, a system providing browser-based and/or native mobile user interfaces. Referring to FIG. 8, in a particular embodiment, an application provision system comprises one or more databases 800 accessed by a relational database management system (RDBMS) 810. Suitable RDBMSs include Firebird, MySQL, PostgreSQL, SQLite, Oracle Database, Microsoft SQL Server, IBM DB2, IBM Informix, SAP Sybase, Teradata, and the like. In this embodiment, the application provision system further comprises one or more application severs 820 (such as Java servers, .NET servers, PHP servers, and the like) and one or more web servers 830 (such as Apache, IIS, GWS and the like). The web server(s) optionally expose one or more web services via app application programming interfaces (APIs) 840. Via a network, such as the Internet, the system provides browser-based and/or mobile native user interfaces.

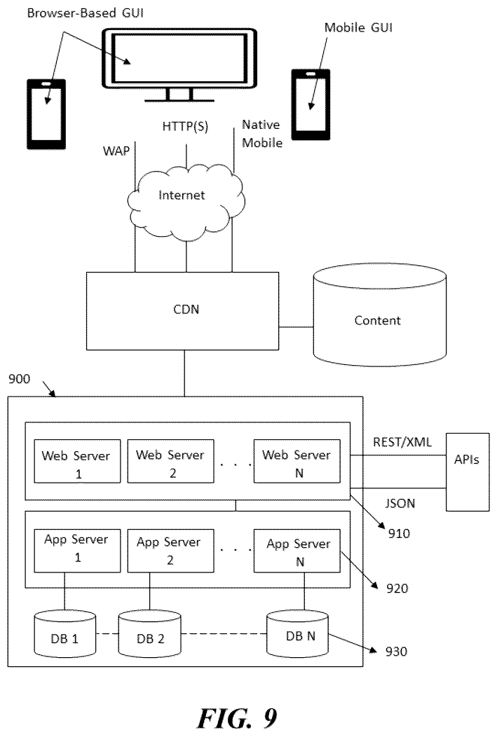

FIG. 9 shows a non-limiting example of a cloud-based web/mobile application provision system; in this case, a system comprising an elastically load balanced, auto-scaling web server and application server resources as well as synchronously replicated databases, in accordance with embodiments disclosed here. Referring to FIG. 9, in a particular embodiment, an application provision system alternatively has a distributed, cloud-based architecture 900 and comprises elastically load balanced, auto-scaling web server resources 910 and application server resources 920 as well synchronously replicated databases 930.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein. In some embodiments, the mobile application is configured to provide a user a way in which to control the swarm of UAVs disclosed herein. For example, the mobile application may provide a user a way in which to deploy a swarm of UAVs carrying a payload. It may allow a user to implement flight directions for the UAVs. It may allow a user to change the flight directions, or other instructions, sent to the UAV in real time, or near real time. It may provide a user a way in which to direct where the swarm of UAVs may deploy the payload and where the swarm of UAVs may travel to in order to adjust a positioning of the payload.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C #, Objective-C, Java™, JavaScript, Pascal, Object Pascal, Python™, Ruby, Rails, VB.NET, WML, and XHTML/HTML with or without CSS, or combinations thereof.

Suitable mobile application development environments are available from several sources. Commercially available development environments include, by way of non-limiting examples, Airplay SDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications. In some embodiments, the standalone application is configured to provide a user a way in which to control the swarm of UAVs disclosed herein. For example, the standalone application may provide a user a way in which to deploy a swarm of UAVs carrying a payload. It may allow a user to implement flight directions for the UAVs. It may allow a user to change the flight directions, or other instructions, sent to the UAV in real time, or near real time. It may provide a user a way in which to direct where the swarm of UAVs may deploy the payload and where the swarm of UAVs may travel to in order to adjust a positioning of the payload.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a standalone application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

In some embodiments, the platforms, systems, media, and methods disclosed herein include one or more databases, or use of the same. In some embodiments, the databases may be configured to store flight information/instructions of UAVs, weather information, information relevant to the applicable environment a swarm of UAVs may be deployed in, and any other relevant information useful for implementing the systems and performing the methods disclosed herein. In view of the disclosure provided herein, those of skill in the art will recognize that many databases are suitable for storage and retrieval of methods for controlling the system comprising a swarm of unmanned aerial vehicles and a payload, or any combination thereof. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It may be understood that various alternatives to the embodiments of the present subject matter described herein may be employed in practicing the present subject matter.

What is claimed is:

1. A system for providing shade to an environment comprising:
a swarm of unmanned aerial vehicles (UAVs);
a payload comprising a surface material and having a plurality of connection points wherein the surface material comprises a degree of translucency; and
a controller programmed to:
cause each UAV of the swarm to attach to at least one of the plurality of connecting points of the payload, such that the swarm of UAVs is configured to collectively support and move the payload;
position each UAV of the swarm at a selected location such that the payload is maintained at the selected location or configured to assume a selected shape to provide a selected degree of shade to the environment;
adjust at least one of the selected location or the selected shape of the payload such that the payload is configured to track a trajectory of the sun; and
adjust the degree of translucency based at least in part on an environmental condition.

2. The system of claim 1, wherein the surface material comprises a plastic surface, paper surface, polymer surface, microfiber surface, or a surface suitable for displaying graphic information.

3. The system of claim 1, wherein one or more UAVs of the swarm comprise a sensor configured to detect the environmental condition, and wherein the environmental condition comprises one or more of an intensity of sunlight, a positioning of the sun, cloud coverage, rain, temperature, or a time of day.

4. The system of claim 1, wherein the controller is further programmed to deploy a plurality of payloads above the environment.

5. The system of claim 4, wherein the plurality of payloads are configured to provide a larger selected degree of shade to the environment, or wherein the plurality of payloads are configured to provide a degree of shade to a plurality of locations of the environment.

6. The system of claim 1, wherein the controller is further programmed to switch out one or more UAVs of the swarm with one or more newly charged UAVs from a charging station as a battery level of the one or more UAVs reaches a drained state.

7. The system of claim 1, wherein the environment comprises a stadium, and wherein the payload is configured to provide a selected degree of shade to attendants in the stadium.

8. The system of claim 1, wherein the environment comprises a stadium, and wherein the swarm of UAVs is configured to hold the payload at an angle that matches an angle of seating in the stadium.

9. The system of claim 8, wherein the payload comprises: (i) a display screen, (ii) an audio system, or (iii) a lighting system, and wherein the controller is further programmed to customize the content of one or more of the display screen, the audio system, or the lighting system to an event being held in the stadium.

10. The system of claim 1, wherein one or more UAVs of the swarm comprise a photovoltaic cell.

11. The system of claim 1, wherein at least one of the location or the selected shape of the payload is further configured to block and collect rainwater.

12. The system of claim 11, wherein the controller is further programmed to instruct the swarm of UAVs to transport collected rainwater to a specified location.
